(19) United States
(12) Patent Application Publication
(10) Pub. No.: US 2024/0419489 A1
(43) Pub. Date: Dec. 19, 2024

(54) High Performance Key-Value Processing

(71) Applicant: NeuroBlade Ltd., Tel Aviv (IL)

(72) Inventors: Elad BARHANIN, Tel Aviv (IL); Eliad HILLEL, Herzliya (IL); Gal DAYAN, Hod Hasharon (IL); Ilan MAYER-WOLF, Tel Aviv (IL); Oded TRAININ, Ra’anana (IL); Yotam ISAAC, Tel Aviv (IL)

(73) Assignee: NeuroBlade Ltd., Tel Aviv (IL)

(21) Appl. No.: 18/813,598

(22) Filed: Aug. 23, 2024

Related U.S. Application Data
(63) Continuation of application No. PCT/IB2023/000133, filed on Feb. 28, 2023.
(60) Provisional application No. 63/314,618, filed on Feb. 28, 2022.
(60) Provisional application No. 63/317,219, filed on Mar. 7, 2022.
(60) Provisional application No. 63/342,767, filed on May 17, 2022.
(60) Provisional application No. 63/408,201, filed on Sep. 20, 2022.
(60) Provisional application No. 63/413,017, filed on Oct. 4, 2022.

(51) Int. Cl. G06F 9/48; G06F 9/30; G06F 9/50

(52) U.S. Cl. CPC G06F 9/4881; G06F 9/30043; G06F 9/5027; G06F 2209/5018

(57) ABSTRACT

A microprocessor includes a function-specific architecture, an interface configured to communicate with an external memory via at least one memory channel, a first architecture block configured to perform a first task associated with a thread, and a second architecture block configured to perform a second task associated with the thread. The second task includes a memory access via the at least one memory channel. The microprocessor further includes a third architecture block configured to perform a third task associated with the thread. The first architecture block, the second architecture block, and the third architecture block are configured to operate in parallel such that the first task, the second task, and the third task are all completed during a single clock cycle associated with the microprocessor.

### CROSS REFERENCES TO RELATED APPLICATIONS

This application claims the benefit of priority of U.S. Provisional Patent Application No. 63/314,618, filed on Feb. 28, 2022; U.S. Provisional Patent Application No. 63/317,219, filed on Mar. 7, 2022; U.S. Provisional Patent Application No. 63/342,767, filed on May 17, 2022; U.S. Provisional Patent Application No. 63/408,201, filed on Sep. 20, 2022; and U.S. Provisional Patent Application No. 63/413,017, filed on Oct. 4, 2022. The foregoing applications are incorporated herein by reference in their entirety.

### BACKGROUND

### Technical Field

The present disclosure generally relates to improvements to processing systems, and, in particular, to increasing processing speed and reducing power consumption.

### Background Information

Details of memory processing modules and related technologies can be found in PCT/IB2018/000995 filed 30 Jul. 2018, PCT/IB2019/001005 filed 6 Sep. 2019, PCT/IB2020/000665 filed 13 Aug. 2020, and PCT/US2021/055472 filed 18 Oct. 2021. Exemplary elements such as XRAM, XDIMM, XSC, and IMPU are available from NeuroBlade Ltd., Tel Aviv, Israel.

### SUMMARY

In an embodiment, a system for generating a hash table may include a plurality of buckets configured to receive a number of unique keys. The system may include at least one processing unit configured to: determine an initial set of hash table parameters; determine, based on the initial set of hash table parameters, a utilization value that results in a predicted probability of an overflow event being less than or equal to a predetermined overflow probability threshold; build the hash table according to the initial set of hash table parameters, if the utilization value is greater than or equal to the number of unique keys; and if the utilization value is less than the number of unique keys, then change one or more parameters of the initial set of hash table parameters to provide an updated set of hash table parameters that result in the utilization value being greater than or equal to the number of unique keys and build the hash table according to the updated set of hash table parameters.

In an embodiment, a microprocessor may include a function-specific architecture and an interface configured to communicate with an external memory via at least one memory channel; a first architecture block configured to perform a first task associated with a thread; a second architecture block configured to perform a second task associated with the thread, wherein the second task includes a memory access via the at least one memory channel; and a third architecture block configured to perform a third task associated with the thread, wherein the first architecture block, the second architecture block, and the third architecture block are configured to operate in parallel such that the first task, the second task, and the third task are all completed during a single clock cycle associated with the microprocessor.

In an embodiment, a system for routing may include a plurality of first layer routing segments including first, second, and third segments, and one or more second layer routing segments including a bypass segment, wherein a separation between the first and second segments is configured as a channel for the third segment, the bypass segment configured for routing continuity between the first and second segments.

In an embodiment, a system for routing may include one or more routing tracks with one or more associated segments, each of the segments independent from adjacent portions of routes, each of the segments configured for communication of a signal other than a signal being communicated by each of the adjacent portions.

In an embodiment, a method for routing may include replacing one or more portions of one or more routes with one or more associated segments, each of the segments independent from adjacent portions of the routes, and each of the segments configured for communication of a signal other than a signal being communicated by each of the adjacent portions of the routes.

In an embodiment, a method for routing may include given an initial layout of cells and an associated initial map of routes for the cells, generating a new layout of the cells with an associated new map of routes for the cells, the new map of routes replacing one or more portions of one or more routes with one or more associated segments, each of the segments independent from adjacent portions of the routes, and each of the segments configured for communication of a signal other than a signal being communicated by each of the adjacent portions of the routes.

In an embodiment, a system may include an interface configured for communication between a first distribution system and a second distribution system, the interface including a plurality of communication channels, a first subset of the communication channels, in a first mode of operation, configured for use in the first mode of operation, a second subset of the communication channels, in a second mode of operation, configured for use in the second mode of operation, and the second subset of communication channels, in the first mode of operation, configured for use in the first mode of operation.

In an embodiment, a system may include a plurality of communication channels, wherein a first subset of the communication channels configured for use in a first mode of operation, and wherein a second subset of the communication channels configured for use in a second mode of operation. At least one portion of the second subset of communication channels may be configured for use in the first mode of operation.

In an embodiment, a system may include an interface configured for communication between a controller and a first module, the interface including a plurality of communication channels implementing a set of pre-defined signals. The first subset of the communication channels may implement a first mode of operation and a second subset of the communication channels may be different from the first subset, in the first mode of operation implementing other than the pre-defined signals.

Consistent with other disclosed embodiments, non-transitory computer readable storage media may store program instructions, which are executed by at least one processing device and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is an example of a computer (CPU) architecture.

FIG. 2 is an example of a graphics processing unit (GPU) architecture.

FIG. 3 is a diagrammatic representation of a computer memory with an error correction code (ECC) capability.

FIG. 4 is a diagrammatic representation of a process for writing data to a memory module.

FIG. 5 is a diagrammatic representation of a process for reading from memory.

FIG. 6 is a diagrammatic representation of an architecture including memory processing modules.

FIG. 7 shows a host provide instructions, data, and/or other input to a memory appliance and read output from the same.

FIG. 8 is an example of implementations of processing systems and, in particular, for data analytics.

FIG. 9 is an example of a high-level architecture for a data analytics accelerator.

FIG. 10 is an example of a software layer for a data analytics accelerator.

FIG. 11 is an example of the hardware layer for a data analytics accelerator.

FIG. 12 is an example of the storage layer and bridges for a data analytics accelerator.

FIG. 13 is an example of networking for a data analytics accelerator.

FIG. 14 is a high-level example of a data analytics architecture.

FIG. 15 is an example of a hash table and related parameters, consistent with the disclosed embodiments.

FIG. 16 is a diagrammatic representation of a system for generating a hash table with a limited risk of overflow, consistent with the disclosed embodiments.

FIG. 17 is an exemplary process for generating and using a hash table, consistent with the disclosed embodiments.

FIG. 18 is a high-level example of a data analytics architecture, consistent with the disclosed embodiments.

FIG. 19 is an example of a data analytics accelerator, consistent with the disclosed embodiments.

FIG. 20 is a high-level example of components and configuration of a key value engine, consistent with the disclosed embodiments.

FIG. 21 is an example of a thread operation, consistent with the disclosed embodiments.

FIG. 22 is an example diagram of architecture, consistent with disclosed embodiments.

FIG. 23 is a flowchart of generating a chip construction specification, consistent with disclosed embodiments.

FIG. 24A is a drawing of connection layers from a top view, consistent with disclosed embodiments.

FIG. 24B is a drawing of connection layers from a side view, consistent with disclosed embodiments.

FIG. 25A is a drawing of a system for routing connections between cells from a top view, consistent with disclosed embodiments.

FIG. 25B is a drawing of a system for routing connections between cells from a side view, consistent with disclosed embodiments.

FIG. 26 is a diagram of routing tracks and routes, for example, of an integrated circuit (IC), consistent with disclosed embodiments.

FIG. 27 is a diagram of connections, for example, of an integrated circuit (IC), consistent with disclosed embodiments.

FIG. 28 is a diagram of a first implementation, consistent with disclosed embodiments.

FIG. 29 is a diagram of a conflict of connections, consistent with disclosed embodiments.

FIG. 30 is a diagram of a second implementation, consistent with disclosed embodiments.

FIG. 31 is a diagrammatic representation of an architecture for a system and method for supplying extra power via a standard interface, consistent with disclosed embodiments.

FIG. 32 is a diagrammatic representation of DIMM deployment, consistent with disclosed embodiments.

FIG. 33A is a diagrammatic representation of DIMM pin connections, consistent with disclosed embodiments.

FIG. 33B is a corresponding chart of pin connections, consistent with disclosed embodiments.

FIG. 34 is a diagrammatic representation of using an external cable to supply extra power, consistent with disclosed embodiments.

FIG. 35 is a diagrammatic representation of an enlarged printed circuit board (PCB) to supply extra power, consistent with disclosed embodiments.

FIG. 36 is a diagrammatic representation of extra power via a standard DIMM interface, consistent with disclosed embodiments.

### DETAILED DESCRIPTION

### Example Architecture

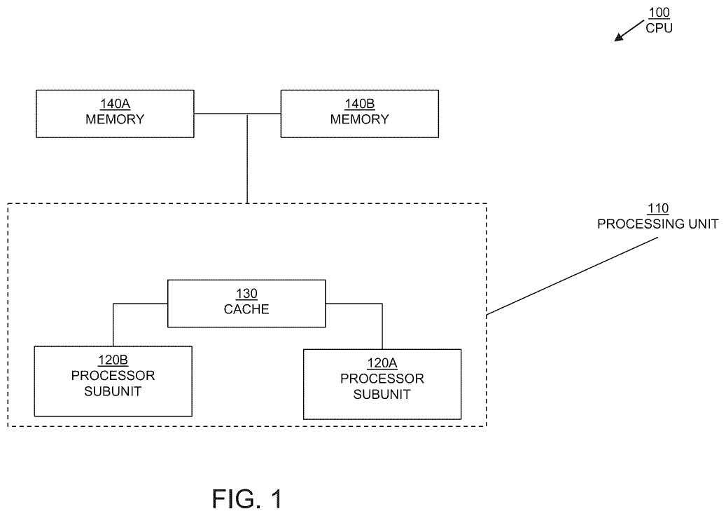

FIG. 1 is an example of a computer (CPU) architecture. A CPU 100 may comprise a processing unit 110 that includes one or more processor subunits, such as processor subunit 120a and processor subunit 120b. Although not depicted in the current figure, each processor subunit may comprise a plurality of processing elements. Moreover, the processing unit 110 may include one or more levels of on-chip cache. Such cache elements are generally formed on the same semiconductor die as processing unit 110 rather than being connected to processor subunits 120a and 120b via one or more buses formed in the substrate containing processor subunits 120a and 120b and the cache elements. An arrangement directly on the same die, rather than being connected via buses, may be used for both first-level (L1) and second-level (L2) caches in processors. Alternatively, in older processors, L2 caches were shared amongst processor subunits using back-side buses between the subunits and the L2 caches. Back-side buses are generally larger than front-side buses, described below. Accordingly, because cache is to be shared with all processor subunits on the die, cache 130 may be formed on the same die as processor subunits 120a and 120b or communicatively coupled to processor subunits 120a and 120b via one or more back-side buses. In both embodiments without buses (e.g., cache is formed directly on-die) as well as embodiments using back-side buses, the caches are shared between processor subunits of the CPU.

Moreover, processing unit 110 may communicate with shared memory 140a and memory 140b. For example, memories 140a and 140b may represent memory banks of shared dynamic random-access memory (DRAM). Although depicted with two banks, memory chips may include between eight and sixteen memory banks. Accordingly, processor subunits 120a and 120b may use shared memories 140a and 140b to store data that is then operated upon by processor subunits 120a and 120b. This arrangement, however, results in the buses between memories 140a and 140b and processing unit 110 acting as a bottleneck when the clock speeds of processing unit 110 exceed data transfer speeds of the buses. This is generally true for processors, resulting in lower effective processing speeds than the stated processing speeds based on clock rate and number of transistors.

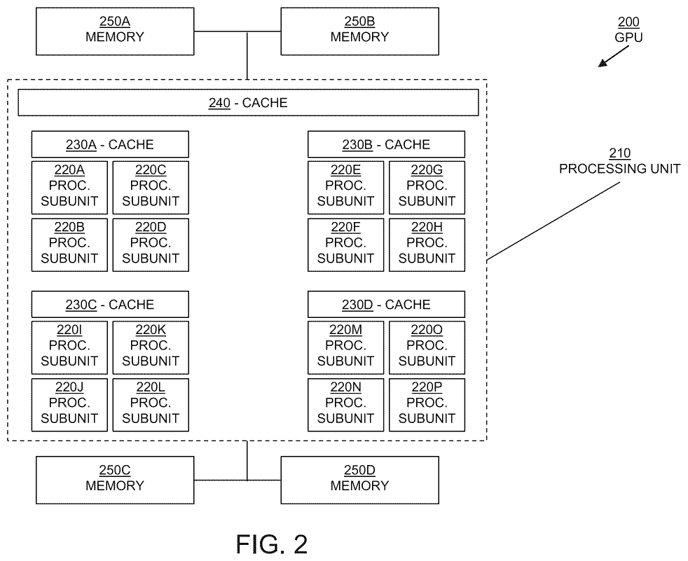

FIG. 2 is an example of a graphics processing unit (GPU) architecture. Deficiencies of the CPU architecture similarly persist in GPUs. A GPU 200 may comprise a processing unit 210 that includes one or more processor subunits (e.g., subunits 220a, 220b, 220c, 220d, 220c, 220f, 220g, 220h, 220i, 220j, 220k, 220l, 220m, 220n, 220o, and 220p). Moreover, the processing unit 210 may include one or more levels of on-chip cache and/or register files. Such cache elements are generally formed on the same semiconductor die as processing unit 210. Indeed, in the example of the current figure, cache 210 is formed on the same die as processing unit 210 and shared amongst all of the processor subunits, while caches 230a, 230b, 230c, and 230d are formed on a subset of the processor subunits, respectively, and dedicated thereto.

Moreover, processing unit 210 communicates with shared memories 250a, 250b, 250c, and 250d. For example, memories 250a, 250b, 250c, and 250d may represent memory banks of shared DRAM. Accordingly, the processor subunits of processing unit 210 may use shared memories 250a, 250b, 250c, and 250d to store data that is then operated upon by the processor subunits. This arrangement, however, results in the buses between memories 250a, 250b, 250c, and 250d and processing unit 210 acting as a bottleneck, similar to the bottleneck described above for CPUs.

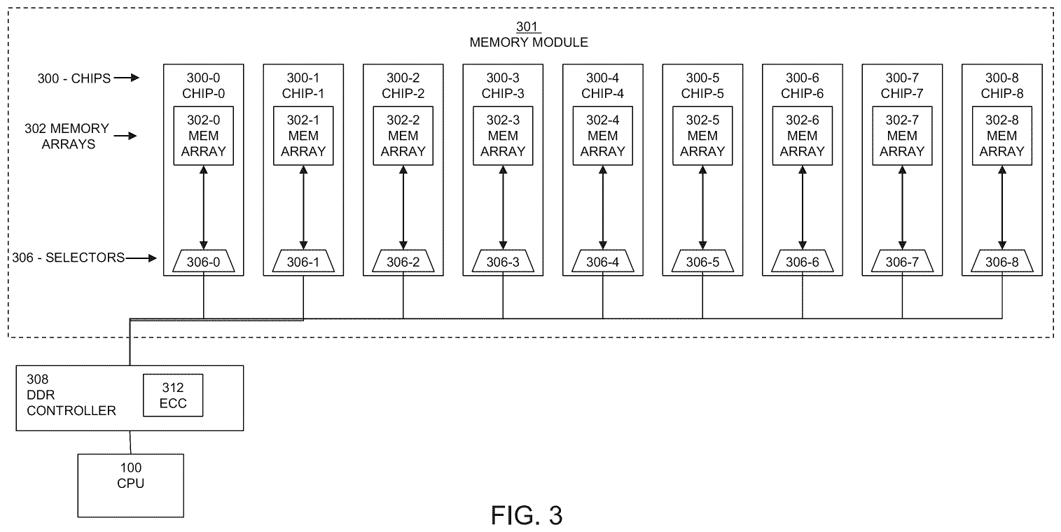

FIG. 3 is a diagrammatic representation of a computer memory with an error correction code (ECC) capability. As shown in the current figure, a memory module 301 includes an array of memory chips 300, shown as nine chips (i.e., chip-0, 100-0 through chip-8, 100-8, respectively). Each memory chip has respective memory arrays 302 (e.g., elements labelled 302-0 through 302-8) and corresponding address selectors 306 (shown as respective selector-0 106-0 through selector-8 106-8). Controller 308 is shown as a DDR controller. The DDR controller 308 is operationally connected to CPU 100 (processing unit 110), receiving data from the CPU 100 for writing to memory, and retrieving data from the memory to send to the CPU 100. The DDR controller 308 also includes an error correction code (ECC) module that generates error correction codes that may be used in identifying and correcting errors in data transmissions between CPU 100 and components of memory module 301.

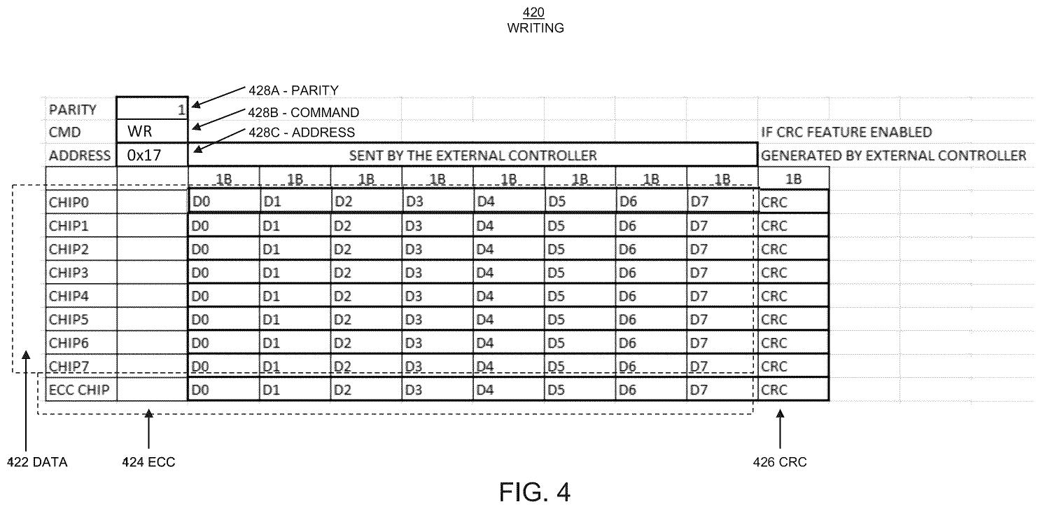

FIG. 4 is a diagrammatic representation of a process for writing data to the memory module 301. Specifically, the process 420 of writing to the memory module 301 can include writing data 422 in bursts, each burst including 8 bytes for each chip being written to (in the current example, 8 of the memory chips 300, including chip-0, 100-0 to chip-7, 100-7). In some implementations, an original error correction code (ECC) 424 may be calculated in the ECC module 312 in the DDR controller 308. The ECC 424 is calculated across each of the chip's 8 bytes of data, resulting in an additional, original, 1-byte ECC for each byte of the burst across the 8 chips. The 8-byte (8×1-byte) ECC is written with the burst to a ninth memory chip serving as an ECC chip in the memory module 301, such as chip-8, 100-8.

The memory module 301 can activate a cyclic redundancy check (CRC) check for each chip's burst of data, to protect the chip interface. A cyclic redundancy check is an error-detecting code commonly used in digital networks and storage devices to detect accidental changes to raw data. Blocks of data get a short check value attached, based on the remainder of a polynomial division of the block's contents. In this case, an original CRC 426 is calculated by the DDR controller 308 over the 8 bytes of data 422 in a chip's burst (one row in the current figure) and sent with each data burst (each row/to a corresponding chip) as a ninth byte in the chip's burst transmission. When each chip 300 receives data, each chip 300 calculates a new CRC over the data and compares the new CRC to the received original CRC. If the CRCs match, the received data is written to the chip's memory 302. If the CRCs do not match, the received data is discarded, and an alert signal is activated. An alert signal may include an ALERT_N signal.

Additionally, when writing data to a memory module 301, an original parity 428A is normally calculated over the (exemplary) transmitted command 428B and address 428C. Each chip 300 receives the command 428B and address 428C, calculates a new parity, and compares the original parity to the new parity. If the parities match, the received command 428B and address 428C are used to write the corresponding data 422 to the memory module 301. If the parities do not match, the received data 422 is discarded, and an alert signal (e.g., ALERT_N) is activated.

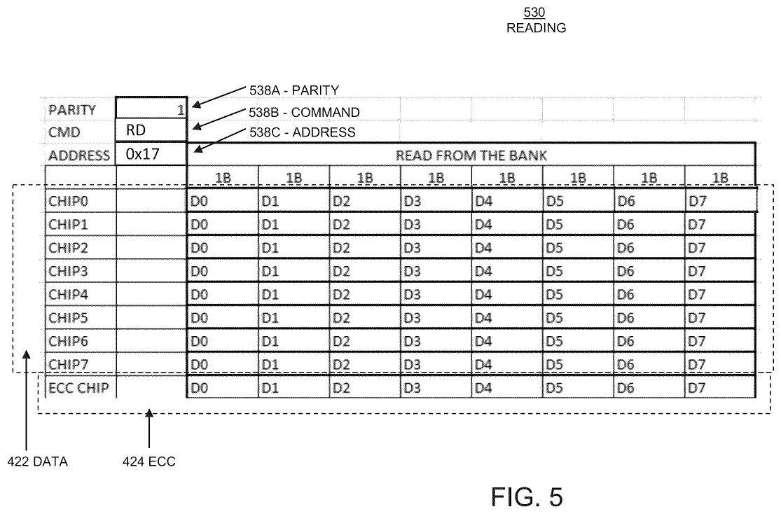

FIG. 5 is a diagrammatic representation of a process 530 for reading from memory. When reading from the memory module 301, the original ECC 424 is read from the memory and sent with the data 422 to the ECC module 312. The ECC module 312 calculates a new ECC across each of the chips' 8 bytes of data. The new ECC is compared to the original ECC to determine (detect, correct) if an error has occurred in the data (transmission, storage). In addition, when reading data from memory module 301, an original parity 538A is normally calculated over the (exemplary) transmitted command 538B and address 538C (transmitted to the memory module 301 to tell the memory module 301 to read and from which address to read). Each chip 300 receives the command 538B and address 538C, calculates a new parity, and compares the original parity to the new parity. If the parities match, the received command 538B and address 538C are used to read the corresponding data 422 from the memory module 301. If the parities do not match, the received command 538B and address 538C are discarded and an alert signal (e.g., ALERT_N) is activated.

### Overview of Memory Processing Modules and Associated Appliances

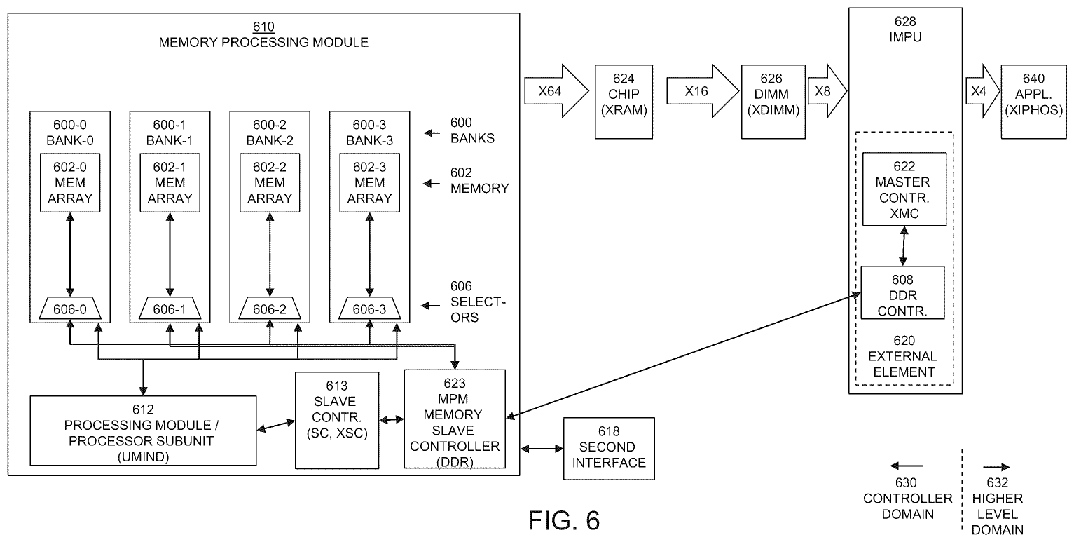

FIG. 6 is a diagrammatic representation of an architecture including memory processing modules. For example, a memory processing module (MPM) 610, as described above, may be implemented on a chip to include at least one processing element (e.g., a processor subunit) local to associated memory elements formed on the chip. In some cases, an MPM 610 may include a plurality of processing elements spatially distributed on a common substrate among their associated memory elements within the MPM 610.

In the example of FIG. 6, the memory processing module 610 includes a processing module 612 coupled with four, dedicated memory banks 600 (shown as respective bank-0, 600-0 through bank-3, 600-3). Each bank includes a corresponding memory array 602 (shown as respective memory array-0, 602-0 through memory array-3, 602-3) along with selectors 606 (shown as selector-0 606-0 to selector-3 606-3). The memory arrays 602 may include memory elements similar to those described above relative to memory arrays 302. Local processing, including arithmetic operations, other logic-based operations, etc. can be performed by processing module 612 (also referred to in the context of this document as a “processing subunit,” “processor subunit,” “logic,” “micro mind,” or “UMIND”) using data stored in the memory arrays 602, or provided from other sources, for example, from other of the processing modules 612. In some cases, one or more processing modules 612 of one or more MPMs 610 may include at least one arithmetic logic units (ALU). Processing module 612 is operationally connected to each of the memory banks 600.

A DDR controller 608 may also be operationally connected to each of the memory banks 600, e.g., via an MPM slave controller 623. Alternatively, and/or in addition to the DDR controller 608, a master controller 622 can be operationally connected to each of the memory banks 600, e.g., via the DDR controller 608 and memory controller 623. The DDR controller 608 and the master controller 622 may be implemented in an external element 620. Additionally, and/or alternatively, a second memory interface 618 may be provided for operational communication with the MPM 610.

While the MPM 610 of FIG. 6 pairs one processing module 612 with four, dedicated memory banks 600, more or fewer memory banks can be paired with a corresponding processing module to provide a memory processing module. For example, in some cases, the processing module 612 of MPM 610 may be paired with a single, dedicated memory bank 600. In other cases, the processing module 612 of MPM 610 may be paired with two or more dedicated memory banks 600, four or more dedicated memory banks 600, etc. Various MPMs 610, including those formed together on a common substrate or chip, may include different numbers of memory banks relative to one another. In some cases, an MPM 610 may include one memory bank 600. In other cases, an MPM may include two, four, eight, sixteen, or more memory banks 600. As a result, the number of memory banks 600 per processing module 612 may be the same throughout an entire MPM 610 or across MPMs. One or more MPMs 610 may be included in a chip. In a non-limiting example, included in an XRAM chip 624. Alternatively, at least one processing module 612 may control more memory banks 600 than another processing module 612 included within an MPM 610 or within an alternative or larger structure, such as the XRAM chip 624.

Each MPM 610 may include one processing module 612 or more than one processing module 610. In the example of FIG. 6, one processing module 612 is associated with four dedicated memory banks 600. In other cases, however, one or more memory banks of an MPM may be associated with two or more processing modules 612.

Each memory bank 600 may be configured with any suitable number of memory arrays 602. In some cases, a bank 600 may include only a single array. In other cases, a bank 600 may include two or more memory arrays 602, four or more memory arrays 602, etc. Each of the banks 600 may have the same number of memory arrays 602. Alternatively, different banks 600 may have different numbers of memory arrays 602.

Various numbers of MPMs 610 may be formed together on a single hardware chip. In some cases, a hardware chip may include just one MPM 610. In other cases, however, a single hardware chip may include two, four, eight, sixteen, 32, 64, etc. MPMs 610. In the particular non-limiting example represented in the current figure, 64 MPMs 610 are combined together on a common substrate of a hardware chip to provide the XRAM chip 624, which may also be referred to as a memory processing chip or a computational memory chip. In some embodiments, each MPM 610 may include a slave controller 613 (e.g., an extreme/Xele or XSC slave controller (SC)) configured to communicate with a DDR controller 608 (e.g., via MPM slave controller 623), and/or a master controller 622. Alternately, fewer than all of the MPMs onboard an XRAM chip 624 may include a slave controller 613. In some cases, multiple MPMs (e.g., 64 MPMs) 610 may share a single slave controller 613 disposed on XRAM chip 624. Slave controller 613 can communicate data, commands, information, etc. to one or more processing modules 612 on XRAM chip 624 to cause various operations to be performed by the one or more processing modules 612.

One or more XRAM chips 624, which may include a plurality of XRAM chips 624, such as sixteen XRAM chips 624, may be configured together to provide a dual in-line memory module (DIMM) 626. Traditional DIMMs may be referred to as a RAM stick, which may include eight or nine, etc., dynamic random-access memory chips (integrated circuits) constructed as/on a printed circuit board (PCB) and having a 64-bit data path. In contrast to traditional memory, the disclosed memory processing modules 610 include at least one computational component (e.g., processing module 612) coupled with local memory elements (e.g., memory banks 600). As multiple MPMs may be included on an XRAM chip 624, each XRAM chip 624 may include a plurality of processing modules 612 spatially distributed among associated memory banks 600. To acknowledge the inclusion of computational capabilities (together with memory) within the XRAM chip 624, each DIMM 626 including one or more XRAM chips (e.g., sixteen XRAM chips, as in the FIG. 6 example) on a single PCB may be referred to as an XDIMM (or eXtremeDIMM or XeleDIMM). Each XDIMM 626 may include any number of XRAM chips 624, and each XDIMM 624 may have the same or a different number of XRAM chips 624 as other XDIMMs 626. In the FIG. 6 example, each XDIMM 626 includes sixteen XRAM chips 624.

As shown in FIG. 6, the architecture may further include one or more memory processing units, such as an intense memory processing unit (IMPU) 628. Each IMPU 628 may include one or more XDIMMs 626. In the FIG. 6 example, each IMPU 628 includes four XDIMMs 626. In other cases, each IMPU 628 may include the same or a different number of XDIMMs as other IMPUs. The one or more XDIMMs included in IMPU 628 can be packaged together with or otherwise integrated with one or more DDR controllers 608 and/or one or more master controllers 622. For example, in some cases, each XDIMM included in IMPU 628 may include a dedicated DDR controller 608 and/or a dedicated master controller 622. In other cases, multiple XDIMMs included in IMPU 628 may share a DDR controller 608 and/or a master controller 622. In one particular example, IMPU 628 includes four XDIMMs 626 along with four master controllers 622 (each master controller 622 including a DDR controller 608), where each of the master controllers 622 is configured to control one associated XDIMM 626, including the MPMs 610 of the XRAM chips 624 included in the associated XDIMM 626.

The DDR controller 608 and the master controller 622 are examples of controllers in a controller domain 630. A higher-level domain 632 may contain one or more additional devices, user applications, host computers, other devices, protocol layer entities, and the like. The controller domain 630 and related features are described in the sections below. In a case where multiple controllers and/or multiple levels of controllers are used, the controller domain 630 may serve as at least a portion of a multi-layered module domain, which is also further described in the sections below.

In the architecture represented by FIG. 6, one or more IMPUs 628 may be used to provide a memory appliance 640, which may be referred to as an XIPHOS appliance. In the example of FIG. 6, memory appliance 640 includes four IMPUs 628.

The location of processing elements 612 among memory banks 600 within the XRAM chips 624 (which are incorporated into XDIMMs 626 that are incorporated into IMPUs 628 that are incorporated into memory appliance 640) may significantly relieve the bottlenecks associated with CPUs, GPUs, and other processors that operate using a shared memory. For example, a processor subunit 612 may be tasked to perform a series of instructions using data stored in memory banks 600. The proximity of the processing subunit 612 to the memory banks 600 can significantly reduce the time required to perform the prescribed instructions using the relevant data.

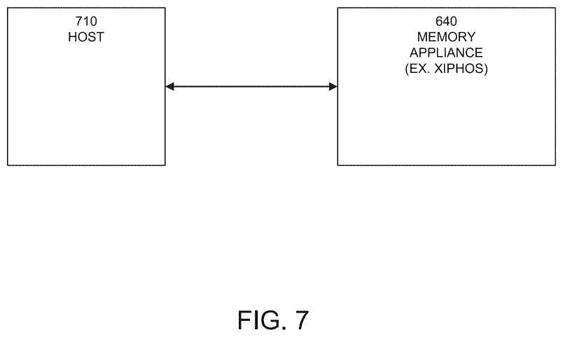

As shown in FIG. 7, a host 710 may provide instructions, data, and/or other input to memory appliance 640 and read output from the same. Rather than requiring the host to access a shared memory and perform calculations/functions relative to data retrieved from the shared memory, in the disclosed embodiments, the memory appliance 640 can perform the processing associated with a received input from host 710 within the memory appliance (e.g., within processing modules 612 of one or more MPMs 610 of one or more XRAM chips 624 of one or more XDIMMs 626 of one or more IMPUs). Such functionality is made possible by the distribution of processing modules 612 among and on the same hardware chips as the memory banks 600 where relevant data needed to perform various calculations/functions/etc. is stored.

The architecture described in FIG. 6 may be configured for execution of code. For example, each processor subunit 612 may individually execute code (defining a set of instructions) apart from other processor subunits in an XRAM chip 624 within memory appliance 640. Accordingly, rather than relying on an operating system to manage multithreading or using multitasking (which is concurrency rather than parallelism), the XRAM chips of the present disclosure may allow for processor subunits to operate fully in parallel.

In addition to a fully parallel implementation, at least some of the instructions assigned to each processor subunit may be overlapping. For example, a plurality of processor subunits 612 on an XRAM chip 624 (or within an XDIMM 626 or IMPU 628) may execute overlapping instructions as, for example, an implementation of an operating system or other management software, while executing non-overlapping instructions in order to perform parallel tasks within the context of the operating system or other management software.

For purposes of various structures discussed in this description, the Joint Electron Device Engineering Council (JEDEC) Standard No. 79-4C defines the DDR4 SDRAM specification, including features, functionalities, AC and DC characteristics, packages, and ball/signal assignments. The latest version at the time of this application is January 2020, available from JEDEC Solid State Technology Association, 3103 North 10th Street, Suite 240 South, Arlington, VA 22201-2107, www.jedec.org, and is incorporated by reference in its entirety herein.

Exemplary elements such as XRAM, XDIMM, XSC, and IMPU are available from NeuroBlade Ltd., Tel Aviv, Israel. Details of memory processing modules and related technologies can be found in PCT/IB2018/000995 filed 30 Jul. 2018, PCT/IB2019/001005 filed 6 Sep. 2019, PCT/IB2020/000665 filed 13 Aug. 2020, and PCT/US2021/055472 filed 18 Oct. 2021. Exemplary implementations using XRAM, XDIMM, XSC, IMPU, etc. elements are not limiting, and based on this description one skilled in the art will be able to design and implement configurations for a variety of applications using alternative elements.

### Data Analytics Processor

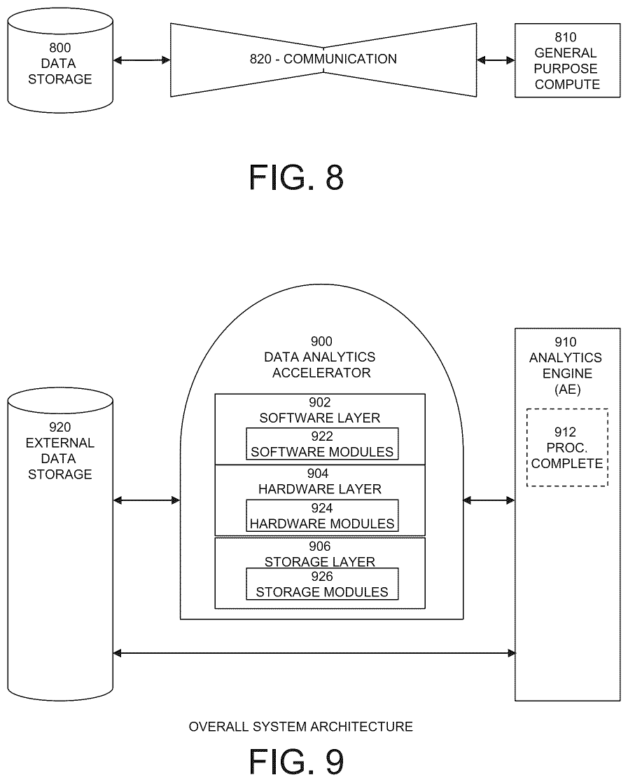

FIG. 8 is an example of implementations of processing systems and, in particular, processing systems for data analytics. Many modern applications are limited by data communication 820 between storage 800 and processing (shown as general-purpose compute 810). Current solutions include adding levels of data cache and re-layout of hardware components. For example, current solutions for data analytics applications have limitations including: (1) Network bandwidth (BW) between storage and processing, (2) network bandwidth between CPUs, (3) memory size of CPUs, (4) inefficient data processing methods, and (5) access rate to CPU memory.

In addition, data analytics solutions have significant challenges in scaling up. For example, when trying to add more processing power or memory, more processing nodes are required, therefore more network bandwidth between processors and between processors and storage is required, leading to network congestion.

FIG. 9 is an example of a high-level architecture for a data analytics accelerator. A data analytics accelerator 900 is configured between an external data storage 920 and an analytics engine (AE) 910 optionally followed by completion processing 912, for example, on the analytics engine 910. The external data storage 920 may be deployed external to the data analytics accelerator 900, with access via an external computer network. The analytics engine (AE) 910 may be deployed on a general-purpose computer. The accelerator may include a software layer 902, a hardware layer 904, a storage layer 906, and networking (not shown). Each layer may include modules such as software modules 922, hardware modules 924, and storage modules 926. The layers and modules are connected within, between, and external to each of the layers. Acceleration may be done at least in part by applying one or more innovative operations, data reduction, and partial processing operations between the external data storage 920 and the analytics engine 910 (or general-purpose compute 810). Implementations of our solutions may include, but are not limited to, features such as, in-line, high parallelism computation, and data reduction. In an alternative operation, (only) a portion of data is processed by the data analytics accelerator 900 and a portion of the data bypasses the data analytics accelerator 900.

The data analytics accelerator 900 may provide at least in part a streaming processor, and is particularly suited, but not limited to, accelerating data analytics. The data analytics accelerator 900 may drastically reduce (for example, by several orders of magnitude) the amount of data which is transferred over the network to the analytics engine 910 (and/or the general-purpose compute 810), reduces the workload of the CPU, and reduces the required memory which the CPU needs to use. The accelerator 900 may include one or more data analytics processing engines which are tailor-made for data analytics tasks, such as scan, join, filter, aggregate etc., doing these tasks much more efficiently than analytics engine 910 (and/or the general-purpose compute 810). An implementation of the data analytics accelerator 900 is the Hardware Enhanced Query System (HEQS), which may include a Xiphos Data Analytics Accelerator (available from NeuroBlade Ltd., Tel Aviv, Israel).

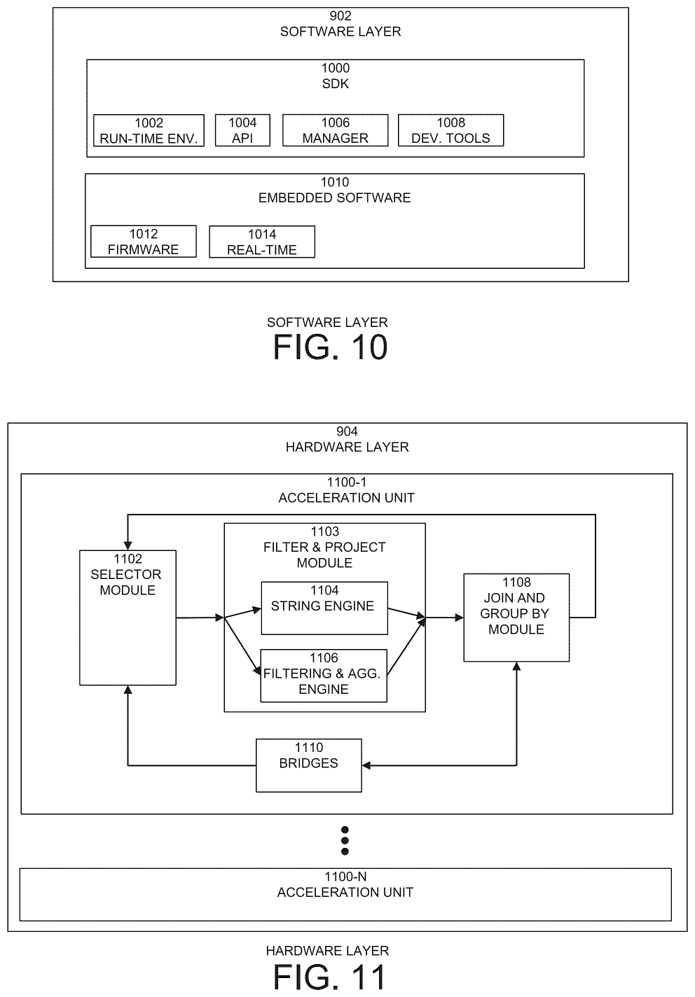

FIG. 10 is an example of the software layer for the data analytics accelerator. The software layer 902 may include, but is not limited to, two main components: a software development kit (SDK) 1000 and embedded software 1010. The SDK provides abstraction of the accelerator capabilities through well-defined and easy to use data-analytics oriented software APIs for the data analytics accelerator. A feature of the SDK is enabling users of the data analytics accelerator to maintain the users' own DBMS, while adding the data analytics accelerator capabilities, for example, as part of the users' DBMS's planner optimization. The SDK may include modules such as:

A run-time environment 1002 may expose hardware capabilities to above layers. The run-time environment may manage the programming, execution, synchronization, and monitoring of underlying hardware engines and processing elements.

A Fast Data I/O providing an efficient API 1004 for injection of data into the data analytics accelerator hardware and storage layers, such as an NVMe array and memories, and for interaction with the data. The Fast Data I/O may also be responsible for forwarding data from the data analytics accelerator to another device (such as the analytics engine 910, an external host, or server) for processing and/or completion processing 912.

A manager 1006 (data analytics accelerator manager) may handle administration of the data analytics accelerator.

A toolchain may include development tools 1008, for example, to help developers enhance the performance of the data analytics accelerator, eliminate bottlenecks, and optimize query execution. The toolchain may include a simulator and profiler, as well as a LLVM compiler.

Embedded software component 1010 may include code running on the data analytics accelerator itself. Embedded software component 1010 may include firmware 1012 that controls the operation of the accelerator's various components, as well as real-time software 1014 that runs on the processing elements. At least a portion of the embedded software component code may be generated, such as auto generated, by the (data analytics accelerator) SDK.

FIG. 11 is an example of the hardware layer for the data analytics accelerator. The hardware layer 904 includes one or more acceleration units 1100. Each acceleration unit 1100 includes one or more of a variety of elements (modules), which may include a selector module 1102, filter and projection module (FPE) 1103, JOIN and Group By (JaGB) module 1108, and bridges 1110. Each module may contain one or more sub-modules, for example, the FPE 1103 which may include a string engine (SE) 1104 and a filtering and aggregation engine (FAE) 1106.

In FIG. 11, a plurality of acceleration units 1100 are shown as first acceleration unit 1100-1 to n^{th} acceleration unit 1100-N. In the context of this description, the element number suffix “-N”, where “N” is an integer, generally refers to an exemplary one of the elements, and the element number without a suffix refers to the element in general or the group of elements. One or more acceleration units 1100, individually or in combination, may be implemented using one or more individual or combination of FPGAs, ASICs, PCBs, and similar. Acceleration units 1100 may have the same or similar hardware configurations. However, this is not limiting, and modules may vary from one to another of the acceleration units 1100.

An example of element configuration will be used in this description. As noted above, element configuration may vary. Similarly, an example of networking and communication will be used. However, alternative and additional connections between elements, feed forward, and feedback data may be used. Input and output from elements may include data and alternatively or additionally includes signaling and similar information.

The selector module 1102 is configured to receive input from any of the other acceleration elements, such as, for example, from at least from the bridges 1110 and the JOIN and Group By engine (JaGB) 1108 (shown in the current figure), and optionally/alternatively/in addition from the filtering and projection module (FPE) 1103, the string engine (SE) 1104, and the filtering and aggregation engine (FAE) 1106. Similarly, the selector module 1102 can be configured to output to any of the other acceleration elements, such as, for example, to the FPE 1103.

The FPE 1103 may include a variety of elements (sub-elements). Input and output from the FPE 1103 may be to the FPE 1103 for distribution to sub-elements, or directly to and from one or more of the sub-elements. The FPE 1103 is configured to receive input from any of the other acceleration elements, such as, for example, from the selector module 1102. FPE input may be communicated to one or more of the string engine 1104 and FAE 1106. Similarly, the FPE 1103 is configured to output from any of the sub-elements to any of the other acceleration elements, such as, for example, to the JaGB 1108.

The JOIN and Group By (JaGB) engine 1108 may be configured to receive input from any of the other acceleration elements, such as, for example, from the FPE 1103 and the bridges 1110. The JaGB 1108 may be configured to output to any of the acceleration unit elements, for example, to the selector module 1102 and the bridges 1110.

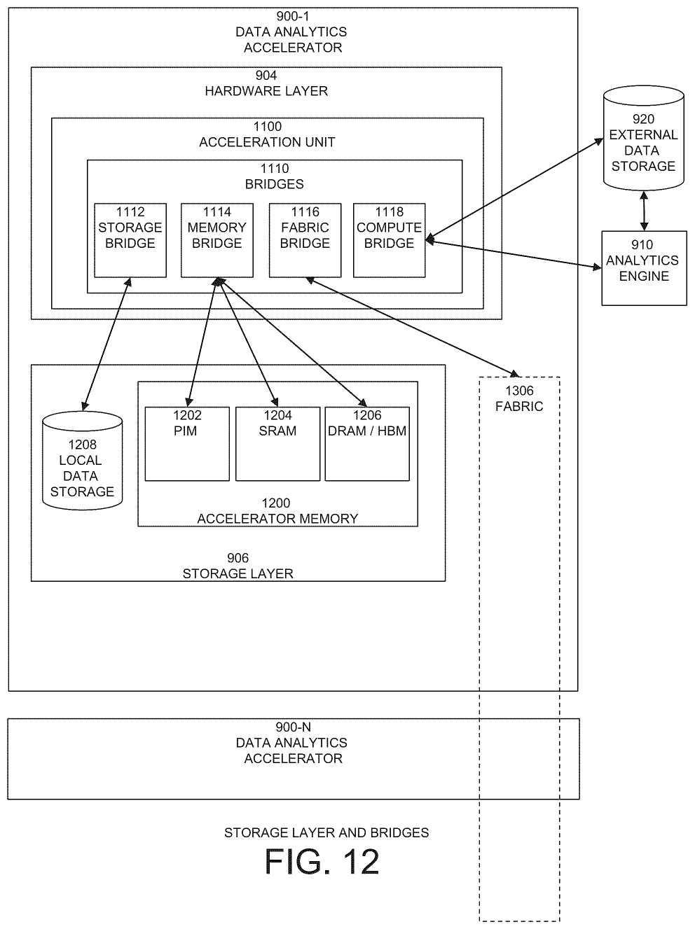

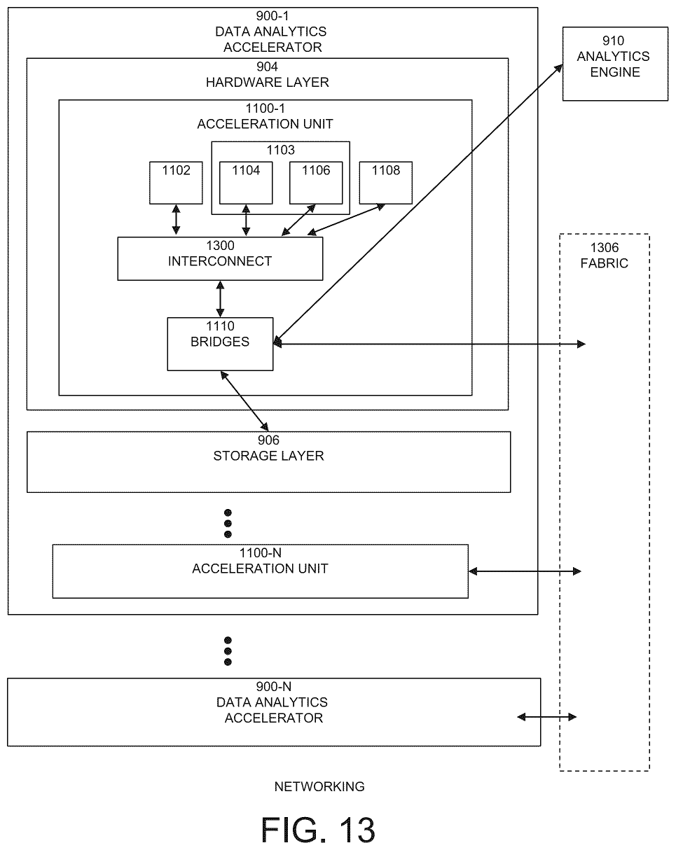

FIG. 12 is an example of the storage layer and bridges for the data analytics accelerator. The storage layer 906 may include one or more types of storage deployed locally, remotely, or distributed within and/or external to one or more of the acceleration units 1100 and one or more of the data analytics accelerators 900. The storage layer 906 may include non-volatile memory (such as local data storage 1208) and volatile memory (such as an accelerator memory 1200) deployed local to the hardware layer 904. Non-limiting examples of the local data storage 1208 include, but are not limited to solid state drives (SSD) deployed local and internal to the data analytics accelerator 900. Non-limiting examples of the accelerator memory 1200 include, but are not limited to FPGA memory (for example, of the hardware layer 904 implementation of the acceleration unit 1100 using an FPGA), processing in memory (PIM) 1202 memory for example, banks 600 of memory 602 in a memory processing module 610, and SRAM, DRAM, and HBM (for example, deployed on a PCB with the acceleration unit 1100). The storage layer 906 may also use and/or distribute memory and data via the bridges 1110 (such as, for example, the memory bridge 1114) via a fabric 1306 (described below in reference to FIG. 13), for example, to other acceleration units 1100 and/or other acceleration processors 900. In some embodiments, storage elements may be implemented by one or more elements or sub-elements.

One or more bridges 1110 provide interfaces to and from the hardware layer 904. Each of the bridges 1110 may send and/or receive data directly or indirectly to/from elements of the acceleration unit 1100. Bridges 1110 may include storage 1112, memory 1114, fabric 1116, and compute 1118.

Bridges configuration may include the storage bridge 1112 interfaces with the local data storage 1208. The memory bridge interfaces with memory elements, for example the PIM 1202, SRAM 1204, and DRAM/HBM 1206. The fabric bridge 116 interfaces with the fabric 1306. The compute bridge 1118 may interface with the external data storage 920 and the analytics engine 910. A data input bridge (not shown) may be configured to receive input from any of the other acceleration elements, including from other bridges, and to output to any of the acceleration unit elements, such as, for example, to the selector module 1102.

FIG. 13 is an example of networking for the data analytics accelerator. An interconnect 1300 may include an element deployed within each of the acceleration units 1100. The interconnect 1300 may be operationally connected to elements within the acceleration unit 1100, providing communications within the acceleration unit 1100 between elements. In FIG. 13, exemplary elements (1102, 1104, 1106, 1108, 1110) are shown connected to the interconnect 1300. The interconnect 1300 may be implemented using one or more sub-connection systems using one or more of a variety of networking connections and protocols between two or more of the elements, including, but not limited to, dedicated circuits and PCI switching. The interconnect 1300 may facilitate alternative and additional connections feed forward, and feedback between elements, including but not limited to looping, multi-pass processing, and bypassing one or more elements. The interconnect can be configured for communication of data, signaling, and other information.

Bridges 1110 may be deployed and configured to provide connectivity from the acceleration unit 1100-1 (from the interconnect 1300) to external layers and elements. For example, connectivity may be provided as described above via the memory bridge 1114 with the storage layer 906, via the fabric bridge 1116 with the fabric 1306, and via the compute bridge 1118 with the external data storage 920 and the analytics engine 910. Other bridges (not shown) may include NVME, PCIe, high-speed, low-speed, high-bandwidth, low-bandwidth, and so forth. The fabric 1306 may provide connectivity internal to the data analytics accelerator 900-1 and, for example, between layers like hardware 904 and storage 906, and between acceleration units, for example between a first acceleration unit 1100-1 to additional acceleration units 1100-N. The fabric 1306 may also provide external connectivity from the data analytics accelerator 900, for example between the first data analytics accelerator 900-1 to additional data analytics accelerators 900-N.

The data analytics accelerator 900 may use a columnar data structure. The columnar data structure can be provided as input and received as output from elements of the data analytics accelerator 900. In particular, elements of the acceleration units 1100 can be configured to receive input data in the columnar data structure format and generate output data in the columnar data structure format. For example, the selector module 1102 may generate output data in the columnar data structure format that is input by the FPE 1103. Similarly, the interconnect 1300 may receive and transfer columnar data between elements, and the fabric 1306 between acceleration units 1100 and accelerators 900.

Streaming processing avoids memory bounded operations which can limit communication bandwidth of memory mapped systems. The accelerator processing may include techniques such as columnar processing, that is, processing data while in columnar format to improve processing efficiency and reduce context switching as compared to row-based processing. The accelerator processing may also include techniques such as single instruction multiple data (SIMD) to apply the same processing on multiple data elements, increasing processing speed, facilitating “real-time” or “line-speed” processing of data. The fabric 1306 may facilitate large scale systems implementation.

Accelerator memory 1200, such as PIM 1202 and HBM 1206 may provide support for high bandwidth random access to memory. Partial processing may produce data output from the data analytics accelerator 900 that may be orders of magnitude less than the original data from storage 920. Thus, facilitating the completion of processing on analytics engine 910 or general-purpose compute with a significantly reduced data scale. Thus, computer performance is improved, for example, increasing processing speeds, decreasing latency, decreasing variation of latency, and reducing power consumption.

Consistent with the examples described in this disclosure, in an embodiment, a system includes a hardware based, programmable data analytics processor configured to reside between a data storage unit and one or more hosts, wherein the programmable data analytics processor includes: a selector module configured to input a first set of data and, based on a selection indicator, output a first subset of the first set of data; a filter and project module configured to input a second set of data and, based on a function, output an updated second set of data; a join and group module configured to combine data from one or more third data sets into a combined data set; and a communications fabric configured to transfer data between any of the selector module, the filter and project module, and the join and group module. The modules may correspond to the modules discussed above in connection with, for example, FIGS. 8-13.

In some embodiments, the first set of data has a columnar structure. For example, the first set of data may include one or more data tables. In some embodiments, the second set of data has a columnar structure. For example, the second set of data may include one or more data tables. In some embodiments, the one or more third data sets have a columnar structure. For example, the one or more data sets may include one or more data tables.

In some embodiments, the second set of data includes the first subset. In some embodiments, the one or more third data sets include the updated second set of data. In some embodiments, the first subset includes a number of values equal to or less than the number of values in the first set of data.

In some embodiments, the one more third data sets include structured data. For example, the structured data may include table data in column and row format. In some embodiments, the one or more third data sets include one or more tables and the combined data set includes at least one table based on combining columns from the one or more tables. In some embodiments, the one or more third data sets include one or more tables, and the combined data set includes at least one table based on combining rows from the one or more tables.

In some embodiments, the selection indicator is based on a previous filter value. In some embodiments, the selection indicator may specify a memory address associated with at least a portion of the first set of data. In some embodiments, the selector module is configured to input the first set of data as a block of data in parallel and use SIMD processing of the block of data to generate the first subset.

In some embodiments, the filter and project module includes at least one function configured to modify the second set of data. In some embodiments, the filter and projection module is configured to input the second set of data as a block of data in parallel and execute a SIMD processing function of the block of data to generate the second set of data.

In some embodiments, the join and group module is configured to combine columns from one or more tables. In some embodiments, the join and group module is configured to combine rows from one or more tables. In some embodiments, the modules are configured for line rate processing.

In some embodiments, the communications fabric is configured to transfer data by streaming the data between modules. Streaming (or stream processing or distributed stream processing) of data may facilitate parallel processing of data transferred to/from any of the modules discussed herein.

In some embodiments, the programmable data analytics processor is configured to perform at least one of SIMD processing, context switching, and streaming processing. Context switching may include switching from one thread to another thread and may include storing the context of the current thread and restoring the context of another thread.

Consistent with the examples described in this disclosure, in an embodiment, a system includes a hardware based, programmable data analytics processor configured to reside between a data storage unit and one or more hosts, wherein the programmable data analytics processor includes: a selector module configured to input a first set of data and, based on a selection indicator, output a first subset of the first set of data; a filter and project module configured to input a second set of data and, based on a function, output an updated second set of data; a communications fabric configured to transfer data between any of the modules. The modules may correspond to the modules discussed above in connection with, for example, FIGS. 8-13.

Consistent with the examples described in this disclosure, in an embodiment, a system includes a hardware based, programmable data analytics processor configured to reside between a data storage unit and one or more hosts, wherein the programmable data analytics processor includes: a selector module configured to input a first set of data and, based on a selection indicator, output a first subset of the first set of data; a join and group module configured to combine data from one or more third data sets into a combined data set; and a communications fabric configured to transfer data between any of the modules. The modules may correspond to the modules discussed above in connection with, for example, FIGS. 8-13.

Consistent with the examples described in this disclosure, in an embodiment, a system includes a hardware based, programmable data analytics processor configured to reside between a data storage unit and one or more hosts, wherein the programmable data analytics processor includes: a filter and project module configured to input a second set of data and, based on a function, output an updated second set of data; a join and group module configured to combine data from one or more third data sets into a combined data set; and a communications fabric configured to transfer data between any of the modules. The modules may correspond to the modules discussed above in connection with, for example, FIGS. 8-13.

### Simplified Hash Table

### Hash Table Overview

Hash tables are data structures that implement associative arrays. They are widely used, particularly for efficient search operations. In associative arrays, data is stored as a collection of key-value pairs (KV), each key being unique. The array has a fixed length n. Mapping of the KV pairs to an array index value is performed using a hash function, i.e., a function that converts the domain of unique keys into an array indices domain ([0, n−1] or [1, n], depending on the convention used. When searching for a value, the provided key is hashed and the resulting hash that corresponds to an array index is used to find the corresponding value stored there.

There are many examples of hash functions. In the context of this description, hash functions may be noted as [Hᵢ], where “i” is an integer denoting a particular hash function. For a function to be chosen as a hash function, the function must often exhibit certain properties, such as a uniform distribution of hash values, meaning that each array index value is equiprobable. Without prior knowledge of all the unique keys, there is no systematic way to construct a perfect hash function, i.e., an injective function that will map every key (K) from the key domain to a unique value in [0, n−1] or [1, n]. Therefore, in most cases, hash functions are imperfect and may lead to collision events, i.e., for an imperfect hash function H, there are at least two unique keys k1 and k2 that may have the same hash value (H(k1)=H(k2)). Collisions are inevitable if the number of indices n in the array is less than the number of unique keys (K). To avoid such collision events, one solution would be to modify the length n and the hash function, but this step would have to be performed for each specific collection of KV pairs, making the process cumbersome. Furthermore, even if the number of unique keys is less than n, a collision may still occur for a certain hash function.

An alternative approach is to use buckets, which include a combination of an array and a linked list for hash tables. All unique keys that are hashed to the same value are stored in the same buckets. The hash function assigns each key to the first location (element) in one of the lists (buckets). When a bucket is full, other buckets are searched until a free space is found. This solution is flexible as this solution allows an unlimited number of unique keys and an unlimited number of collisions. For this implementation, the average cost of a search is the cost of finding the required key in the average number of unique keys in the buckets. However, depending on the collection of KV pairs, the distribution of hash values may not be uniform, so a large number of unique keys may be placed in the same bucket, resulting in a high search cost, with the worst-case scenario being that all keys are hashed into the same bucket. To avoid this scenario, the size of the buckets is fixed, i.e., each bucket can only contain a fixed number of elements (KV pairs).

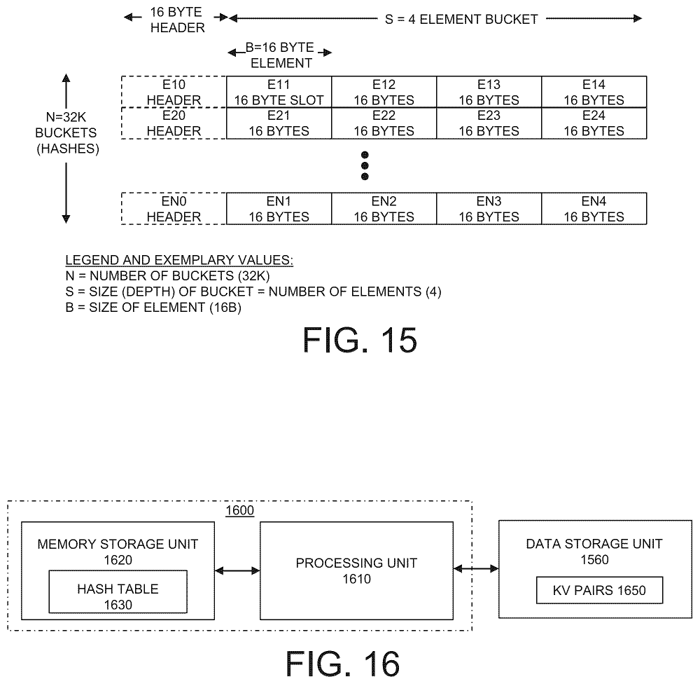

FIG. 15 illustrates a non-limiting example of a hash table and related parameters. Exemplary hash table parameters are referenced:
N=NUMBER OF BUCKETS (32K)
S=SIZE (DEPTH) OF BUCKET (4 elements)
B=SIZE OF ELEMENT (16 Bytes)

Several additional hash table parameters may be also used to further describe the hash table such as:
A=SIZE OF KEY (16 Bytes)
K=NUMBER OF UNIQUE KEYS TO INSERT
NE=NUMBER OF ELEMENTS (N*S)
M=AVAILABLE MEMORY (memory allocated and available for this task) Hash tables using buckets may also include bucket headers as shown in FIG. 15.

Headers may include different data entries. For example, a header may comprise the hash value corresponding to the bucket, or a bucket-fill indicator. Further, hash table elements may include (store) a KV pair but also additional data entries, such as a hash value for example.

The values above and below are non-limiting examples. For example, in one implementation, the size of the hash table is the size of the available memory (N*S*B=NE*B=M) (minus any header or similar data), the size of each element is the same as the size of each key (B=A), and the number of unique keys (K) to be inserted is less than or equal to the number of elements (NE) in the hash table (K≤N*S=NE).

Fixing bucket sizes may limit search costs, but can create another problem: overflow events. An overflow occurs when the bucket for a new KV pair is full. For example, referring to FIG. 15, if a new KV pair results in a hash value, pointing to the first row of the hash table, but the elements E11 to E14 are already occupied, the question arises as to where to place the new KV pair. There are various techniques/algorithms for dealing with overflow events and placing the extra KV pair in the hash table. Resolving overflows mainly consists of looking into the hash table and finding another open slot to hold the KV pairs that caused the overflow. Some of these techniques rely on rehashing techniques, i.e., using a second hash operation until an empty slot is found. This second hash operation may use a different hash function or the same hash function as the one initially applied. In other cases, a hash seed (a random value that selects a specific hash function) may be changed.

One or more hash functions [Hᵢ] may be used. The number of hash functions used may range from 1 to D, where (D) is the number of choices for insertion. For example, if the number of choices is two (D=2), then correspondingly two hash functions [notated as H₁, H₂] may be used during the construction to insert unique keys into the table, for example using a “choice of two” algorithm. For each key, each hash function generates a corresponding hash value, each hash value points to a different bucket and depending on the status (e.g., how full) of the buckets, one of the buckets is selected for inserting the key into the hash table. Alternatives include using a single hash function and using two or more portions of the resulting hash used for the corresponding two or more choices. These techniques are generally complex to implement in hardware, have variable latency and are not limited in latency (only by memory size). The present disclosure describes solutions for mitigating or overcoming one or more of the above problems associated with overflow events, among other problems.

System for Generating a Hash Table with No More than a Predetermined Risk of Overflow

A possible solution to avoid dealing with overflow events that occur during the construction or use of a hash table may be to construct a hash table that has no more than a predetermined risk of overflow. Disclosed embodiments may perform a novel analysis prior to use to estimate the risk of overflow and generate a hash table that limits that risk of overflow to no more than the predetermined amount. In particular, hash tables can be constructed that lack overflow, and thus do not need to handle overflow events. During use, if there is no indication of overflow, there is no need for overflow management.

FIG. 16 is a diagrammatic representation of a system for generating a hash table with a limited risk of overflow consistent with the disclosed embodiment. The hash table may comprise a plurality of buckets configured to receive a number of unique keys. In some embodiments, a system 1600 may comprise at least one processing unit 1610 configured to: determine an initial set of hash table parameters; determine, based on the initial set of hash table parameters, a utilization value that results in a predicted probability of an overflow event being less than or equal to a predetermined overflow probability threshold; build the hash table according to the initial set of hash table parameters, if the utilization value is greater than or equal to the number of unique keys; and if the utilization value is less than the number of unique keys, then change one or more parameters of the initial set of hash table parameters to provide an updated set of hash table parameters that result in the utilization value being greater than or equal to the number of unique keys and build the hash table according to the updated set of hash table parameters. Additional details regarding this technique are provided in the sections below.

In some embodiments, the at least one processing unit 1610 may include any logic-based circuitry capable of performing calculations and generating a hash table. Examples of logic-based circuitry may include combinational circuitry, state circuitry, processors, ASICS, FPGAs, CPUs, or GPUs.

In some embodiments, the generated hash table may be stored in a memory storage unit, such as memory storage unit 1620. KV pairs 1650 used to fill the hash table may be stored in a data storage unit, such as data storage unit 1640. The at least one processing unit 1610 may communicate with the memory storage unit 1620 and the data storage unit 1640. Memory storage unit 1620 and data storage unit 1640 may be deployed on semiconductor memory chips, computational memory, flash memory storage, hard disk drives (HDD), solid-state drives, one or more dynamic random-access memory (DRAM) modules, static RAM modules (SRAM), cache memory modules, synchronous dynamic RAM (SDRAM) modules, DDR4 SDRAM modules, or one or more dual inline memory modules (DIMMs). In some embodiments, the memory storage unit may be internal or external to the system. For example, as illustrated in FIG. 16, memory storage unit 1620 is internal to system 1600. In some embodiments, the data storage unit may be internal or external to the system. For example, as illustrated in FIG. 16, data storage unit 1640 is external to system 1600. In some embodiments, memory storage unit 1620 and data storage unit 1630 may be implemented on a common hardware device.

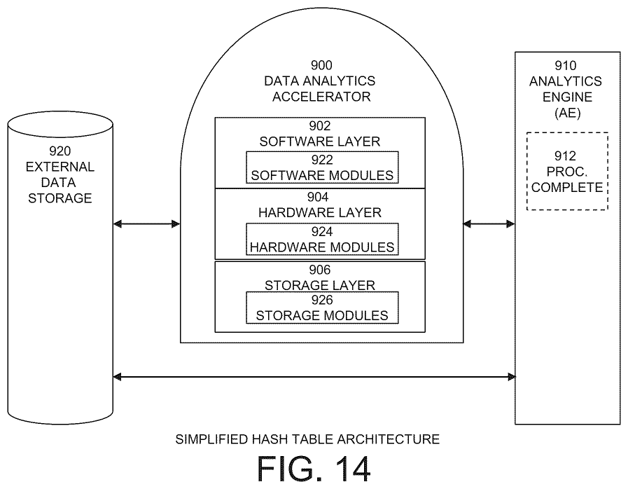

In some embodiments, the at least one processing unit may be an accelerator processor. FIG. 14 is an example of an architecture consistent with the disclosed embodiments. In some embodiments, the at least one processing unit may be an accelerator processor. Data analytics acceleration 900 may be done at least in part by applying innovative operations between external data storage 920 and analytics engine 910 (e.g., a CPU), optionally followed by completion processing 912. The software layer 902 may include software processing modules 922, the hardware layer 904 may include hardware processing modules 924, and the storage layer 906 may include storage modules 926.

Referring to FIG. 14, non-limiting implementations of the at least one processor 1610 may be done using one or more software modules 922 of the software layer 902, one or more hardware processing modules 924 of the hardware layer 904, or a combination thereof. Analytics engine 910 external data storage 920 and storage layer 906 may be used to implement memory storage unit 1620 and data storage unit 1640.

In some embodiments, the initial set of hash table parameters may include one or more of a number of buckets (N), a bucket size(S), and a number of choices (D). For example, referring to FIG. 15, the number of buckets (N) may be equal to 32K, the bucket size(S) to 4 and the number of choices (D) to 2.

Additionally, in some embodiments, the initial set of hash table parameters may further include at least one of an element size (B), a size of each unique key (A), one or more hash function seeds, an available memory (M) from a memory storage unit or a combination thereof. For example, referring to FIG. 15, the size of each element of the hash table is equal to 16 bytes, meaning that a size of the overall hash table (NE*B) is at a minimum (without taking into account the headers) of 2048 Kbytes. In some embodiments, a size of the overall hash table may be equal to the available (or allocated) memory M from a memory storage unit. In some other embodiments, the size of the overall hash table may be less than the available memory M from a memory storage unit. For example, referring to FIG. 15, the available memory M from the memory storage unit 1620 may be equal to or greater than 2048 Kbytes. Further, in some embodiments, the element size (B) may be equal to the size of each key. Alternatively, in some other embodiments, the element size (B) may be greater than the size of each key. For example, referring to FIG. 15, the size of each key may be less than or equal to 16 bytes.

Once the initial set of hash table parameters has been determined, the at least one processing unit may determine, based on the determined initial set of hash table parameters, a utilization value (C) that results in a predicted probability of an overflow event being less than or equal to a predetermined overflow probability threshold. Above and throughout this disclosure, the term “utilization value (C)” may refer to a maximum number of filled elements of the hash table that, given the initial set of hash table parameters, would cause an overflow event with a limited probability, i.e., a maximum number of filled elements for which the probability of causing an overflow event would be is less than or equal to a predetermined threshold probability. In some embodiments, the determination of the utilization value (C) may be based on an asymptotic balanced formula applied to the initial set of hash table parameters. For example, a utilization value (C) may be calculated using an asymptotic bounds formula for the first collision (first bucket overflow), based on the number of buckets (N), the size of buckets(S) and the number of choices (D). A non-limiting example of an asymptotic balanced formula is:

$$C ( N , S ) \approx N ( ( S + ln N ) - \sqrt{{( S + ln N )}^{2} - {S}^{2}} )$$

In some other embodiments, the determination of the utilization value (C) may also be based on operational and other parameters, such as an acceptable probability of collision.

The probability of an overflow event for a hash table may depend on a set of hash table parameters and a number of unique keys to be inserted into the hash table. For a given number of unique keys (K) to be inserted into a hash table, the probability of an overflow event may change depending on the value of certain hash table parameters. For example, the greater the number of buckets (N) and the greater the size of the buckets(S), the lower the probability of an overflow event. Conversely, for a given set of hash table parameters, the probability of an overflow event may increase with the number of unique keys to be inserted. Accordingly, in some embodiments, the predicted probability of an overflow event may be determined based, at least in part, on the determined initial set of hash table parameters. For a given initial set of hash table parameters, the system may determine the utilization value by finding a value for a number of unique keys to be inserted such that the probability of an overflow event is less than or equal to the predetermined overflow probability threshold.

The utilization value and the predetermined overflow probability threshold are related. For a known set of hash table parameters, the maximum number of filled elements, i.e., the utilization value, is subject to change with a predetermined probability threshold of an overflow event. For example, the higher the predetermined probability threshold of an overflow event, the less restrictive the number of filled elements and the higher the utilization value. In other words, if the system accepts a high probability threshold of overflow events, a higher number of elements may be filled in the hash table.

The predetermined overflow probability threshold may be selectable. In some embodiments, the predetermined overflow probability threshold may be greater than or equal to 0%. For example, the predetermined overflow probability threshold may be selected a s0%, 1%, 2%, 5%, 10%, 20%, etc. Where the predetermined overflow probability threshold is set to 0%, this means there is no tolerance for an overflow event. In this case, the utilization value results in an overflow event probability equal to 0%. Based on this constraint, however, appropriate hash table parameters can be selected. In many cases, however, some level of risk of experiencing an overflow event may be tolerated, especially as allowing for even a small amount of overflow event risk may significantly increase a level of flexibility in selecting hash table parameters yielding at least a desired utilization value. For example, in some embodiments, the predetermined overflow probability threshold may be less than 10%. For example, the predetermined overflow probability threshold may be equal to 9%, 8%, 5%, 3%, or 0%, etc. (or other values less than 10%).

The utilization value (C) may be evaluated relative to the number of unique keys (K) to be inserted into the hash table. If the utilization value (C) is less than the number of unique keys to be inserted (C<K), then generating a hash table with the initial set of hash table parameters may result in more than a desired level of risk (e.g., a risk greater than the predetermined overflow probability threshold) that an overflow event will occur. Therefore, the utilization value (C) may need to be increased.

If the utilization value is less than the number of unique keys, the at least one processing unit 1610 may change one or more parameters of the initial set of hash table parameters to provide an updated set of hash table parameters that result in the utilization value being greater than or equal to the number of unique keys. Any of the parameters of the initial set of hash table parameters may be changed. In some embodiments, changing one or more parameters of the initial set of hash table parameters may include: allocating more memory (M) for the hash table; reducing the number of unique keys (K) by using two or more tables; increasing or decreasing the number of buckets (N); increasing or decreasing the size(S) of the bucket; increasing or decreasing the number of choices (D); changing one or more hash functions (H); changing the seed for one or more hash functions; or combinations thereof.

One strategy to reduce the probability of an overflow event and increase the utilization value would be to generate a hash table with a large number of elements. In this context, a large number of elements may refer to a number of elements that exceeds (or significantly exceeds) the number of unique keys to be inserted into the hash table. For example, a large number of elements relative to the number of unique keys to be inserted may be equal to the number of unique keys to be inserted multiplied by a proportionality constant greater than 1, 2, 5, or any other appropriate value. Such a hash table may be constructed in many ways, e.g., using a number of buckets (N) or a bucket size(S) comparable to the number of unique keys to be inserted (K), such that the product N*S=NE exceeds K.

However, constructing a hash table with a large number of elements (NE) relative to the number of unique keys (K) to be inserted may sometimes not be possible as the overall size of the table is limited by the available memory (M), or amount of memory allocated. And, even in situations where such a table is possible to construct, using this table may result in a low hash table fill ratio. The filling ratio may correspond to the ratio of the number of unique keys to be inserted to the number of elements in the hash table. For example, if the number of elements (NE) is equal to 5 times the number of unique keys, the maximum possible filling ratio of the hash table would be equal to 20% (only 20% of all hash table elements would be occupied by a KV pair). An element may be considered filled or occupied if the element contains at least one data. In some embodiments an element may contain a KV pair and additional data entries. In some embodiments, an element may contain only a key. While such an approach to hash table construction may reduce the probability of experiencing an overflow event, this approach also can result in inefficient use of allocated memory. In the example above, a hash table with a low filling ratio (e.g., 20%) indicates that most of the memory allocated to the hash table is not being used. In this example, 80% of the allocated memory would be dedicated to empty elements.

In order to avoid generating a hash table with a low filling ratio, the ratio of the number of unique keys (K) to be inserted to the number of elements (NE) may be evaluated against a predetermined filling ratio threshold. In some embodiments, building the hash table according to an initial set of hash table parameters may occur when a ratio of the number of unique keys to the number of elements in the hash table (for the initial set of hash table parameters) is greater than or equal to a predetermined filling ratio threshold value. In some embodiments, the number of elements (NE) associated with the hash table may be equal to a number of buckets (N) multiplied by a bucket size(S), and the number of elements (NE) may be greater than or equal to the number of unique keys (K) to insert into the hash table. Using the filling ratio threshold as a constraint for building the hash table may assist in “right sizing” the allocated memory. Enough memory may be allocated such that the constructed hash table limits the risk of experiencing an overflow event to less than the predetermined overflow probability threshold. On the other hand, however, the amount of memory allocated to the hash table may be small enough to ensure that, in use, the predetermined filling ratio threshold value is achieved or exceeded.

In cases where the ratio of the number of unique keys (K) to be inserted to the number of elements (NE) is less than the predetermined filling ratio threshold, the constructed hash table would result in use of allocated memory space that is below a desired efficiency threshold. The predetermined filling ratio threshold may be selected to result in a hash table for which use of allocated memory space that meets or exceeds a desired efficiency level. In some embodiments, the predetermined filling ratio threshold value may be at least 80%. For example, the predetermined filling ratio threshold may be equal to 80%, 85%, 90%, or 95%, or higher, thereby ensuring a certain level of efficiency for the operations.

In determining whether and how to build a hash table, the at least one processing unit 1610 may evaluate two criteria based on a set of hash table parameters: 1) whether the utilization value (C) is greater than or equal to the number of unique keys (K) and 2) whether the ratio of the number of unique keys to a number of elements in the hash table is greater than or equal to a predetermined usage threshold value. In some embodiments, building the hash table according to the updated set of hash table parameters may occur when a ratio of the number of unique keys to a number of elements in the hash table is less than the predetermined filling ratio threshold value, and wherein changing the one or more parameters of the initial set of hash table parameters to provide the updated set of hash table parameters may further result in the ratio of the number of unique keys to the number of elements in the hash table being greater than or equal to the predetermined filling ratio threshold value. The first criterion may ensure the construction of a hash table with a limited risk of overflow (e.g., less than or equal to a desired risk level). The second criterion may result in a hash table with a filling ratio at or exceeding a desired level. The values of the predetermined overflow probability threshold and the predetermined filling ratio threshold may represent a trade-off for generating a hash table (e.g., a hash table that balances filling ratio and memory usage levels with an acceptable risk of experiencing an overflow event).

If one of these two criteria is not met, different hash table parameters may be selected. For example, if the utilization value is less than the number of unique keys or the ratio of the number of unique keys to the number of elements in the hash table is less than the predetermined filling ratio threshold value, the at least one processing unit 1610 may change one or more parameters of the initial set of hash table parameters to provide an updated set of hash table parameters. This process can continue until an updated set of hash table parameters is selected such that the utilization value is greater than or equal to the number of unique keys and the ratio of the number of unique keys to the number of elements in the hash table is greater than or equal to the predetermined filling ratio threshold value. Any of the parameters of the initial set of hash table parameters may be changed, depending on the specifics of the application. In some embodiments, changing one or more parameters of the initial set of hash table parameters may include: allocating more memory (M) for the hash table, reducing the number of unique keys (K), for example, by using two or more tables, increasing or decreasing the number of buckets (N), increasing or decreasing the size(S) of the bucket, increasing or decreasing the number of choices (D), changing one or more hash functions (H), changing the seed for one or more hash functions, or a combination thereof.

Changing the value of a parameter in the set of hash table parameters may have differing effects on the utilization value and the ratio of the number of unique keys to be inserted to the number of elements. For example, increasing the number of buckets (N) may result in an increase in the utilization value (C) but a decrease in the ratio of the number of unique keys to be inserted to the number of elements, since the number of elements (NE) increases with the number of buckets (N). The at least one processing unit 1610 may therefore search for parameter values that satisfy both criteria. Similarly, when changing one or more parameters, the at least one processing unit 1610 may find a combination of values for the updated set of hash table parameters that satisfies both criteria. Once an updated set of hash table parameters is identified that results in the utilization value being greater than or equal to the number of unique keys and the ratio of the number of unique keys to the number of elements in the hash table being greater than or equal to the predetermined filling ratio threshold value, the at least one processing unit may build the hash table according to the updated set of hash table parameters.

Since hash functions involve some degree of randomness and no perfect hash function may be constructed in advance without knowing the collection of KV pairs, an overflow event may still occur during construction even if the precautions mentioned in the above section are taken. Accordingly, there is a need to manage overflow events. A disclosed system may perform an innovative operation to deal with and manage overflow events on a hash table. In some embodiments, the at least one processing unit is further configured to: detect an overflow event; in response to the detected overflow event, change one or more parameters of the initial or updated set of hash table parameters used to build the hash table to provide a refined set of hash table parameters; and re-build the hash table using the refined set of hash table parameters.

In some embodiments, the refined set of hash table parameters may include more buckets than a number of buckets associated with the initial or updated set of hash table parameters. For example, if the number of buckets (N) associated with the initial or updated set of hash table parameters is equal to 32K, a refined set of hash table parameters may comprise a number of buckets (N) equal to 64K, 128K, 256K or any other suitable number of buckets greater than 32K. Increasing the number of buckets (N) may result in a decrease in the probability of overflow events and a higher utilization value (C).

In some embodiments, the refined set of hash table parameters may include a bucket size greater than a bucket size associated with the initial or updated set of hash table parameters. For example, if the bucket size(S) associated with the initial or updated set of hash table parameters is equal to 4, a refined set of hash table parameters may comprise a bucket size(S) equal to 6, 8, 10, 20 or any other suitable bucket size greater than 4. Increasing the bucket size(S) may result in a decrease in the probability of overflow events, a higher utilization value (C), but also to an increase in look-up costs.

In some embodiments, the refined set of hash table parameters may include a number of choices greater than a number of choices associated with the initial or updated set of hash table parameters. For example, if the number of choices (D) associated with the initial or updated set of hash table parameters is equal to 2, a refined set of hash table parameters may comprise a number of choices (D) equal to 3, 4, 8, 10 or any other suitable number of choices greater than 2. Increasing the number of choices (D) may result in a decrease in the probability of overflow events and a higher utilization value (C).

In some embodiments, after providing the refined set of hash table parameters, the at least one processing unit may determine, based on the refined set of hash table parameters, a new utilization value that results in a new predicted probability of a new overflow event being less than or equal to the predetermined overflow probability threshold; and verify that the new utilization value is greater than or equal to a number of unique keys before re-building the hash table using the refined set of hash table parameters.

Alternatively, in some embodiments, after providing the refined set of hash table parameters, the at least one processing unit may determine, based on the refined set of hash table parameters, a new utilization value that results in a new predicted probability of a new overflow event being less than or equal to the predetermined overflow probability threshold; determine a new ratio of the number of unique keys to the number of elements; and verify that the new utilization value is greater than or equal to a number of unique keys and that the new ratio of the number of unique keys to the number of elements is greater than or equal to a new predetermined filling ratio value, before re-building the hash table using the refined set of hash table parameters.

In some embodiments, the new predicted probability of a new overflow event may be equal to or different from the predicted probability of an overflow event based the initial or updated set of hash table parameters. For example, to further avoid the risk of a new overflow event, the at least one processing unit may decrease the value of the predetermined overflow probability threshold. In some embodiments, the new predetermined filling ratio value may be equal to or different from the predetermined filling ratio value that resulted from the initial or updated set of hash table parameters. For example, to further avoid the risk of a new overflow event, the at least one processing unit may decrease the value of the predetermined filling ratio threshold such that a table with a lower filling ratio would satisfy the criteria for the value of the ratio of the number of unique keys to the number of elements.

In some embodiments, detecting the overflow event may occur during the building of the hash table or an operation performed on the hash table. Examples of operations performed on the hash table may include insert operations. When a new KV pair is added to the hash table, there is potentially a non-zero risk of causing an overflow event. If an overflow event occurs in these circumstances, the at least one processing unit may, in response to the detection of the overflow event, modify one or more parameters of an initial or updated set of hash table parameters used to construct the hash table to provide a refined set of hash table parameters and rebuild the hash table based on the refined set of hash table parameters except that the number of unique keys to be inserted is now increased by at least one key.

### Generation and Operation of a Hash Table

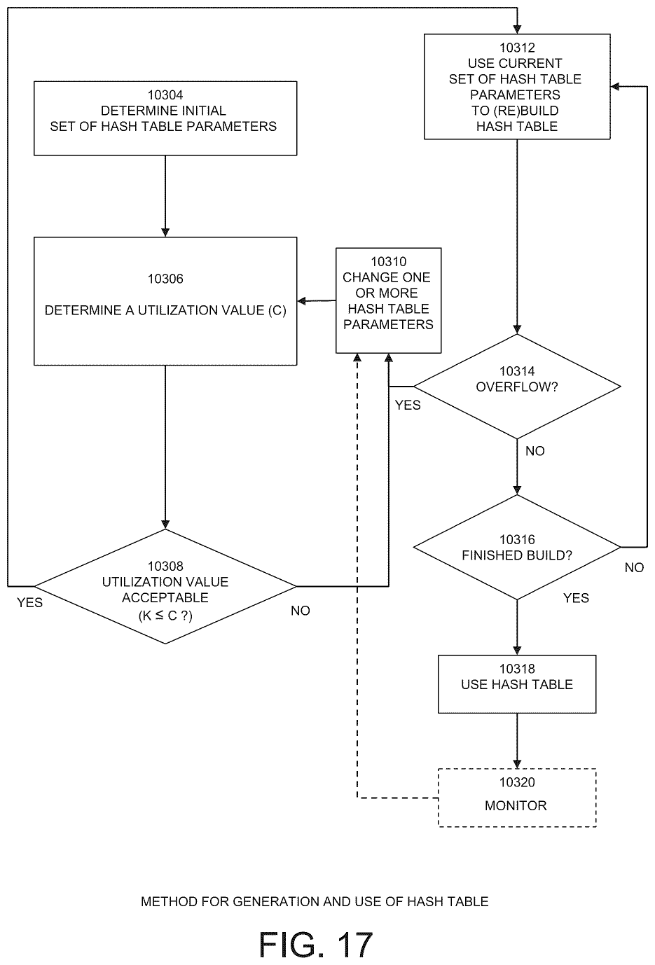

FIG. 17 is an example of an exemplary method for generating and using hash tables. Such a method may be performed by at least one processing unit, such as processing unit 1610. In step 10304, an initial set of parameters is selected. At step 10306, a utilization value (C) is calculated that results in a predicted probability of an overflow event being less than or equal to a predetermined overflow probability threshold, for example, by using an asymptotic bounds formula for the first bucket overflow, based on the number of buckets (N), the size of the buckets (S) and the number of choices (D). A determination is made at step 10308 whether the utilization value is acceptable. For example, if the number of unique keys (K) is less than or equal to the utilization value (C). In the current example of N=32K, S=4 and D=2, the number of unique keys (K) to be inserted is 112K, and the utilization value (C) is 114K.

If the utilization value is not acceptable (step 10308, no), one or more parameters are modified 10310, and a new utilization value is calculated 10306. Any of the parameters may be modified depending on the specifics of the application. Some non-limiting examples of parameter changes are:
more memory (M) can be allocated for the hash table,
the number of unique keys (K) can be reduced by using two or more tables,
the number of buckets (N) can be increased or decreased,
the size(S) of the bucket can be increased (or decreased),
the number of choices (D) can be increased or decreased,
the hash function (H) being used can be changed, and
the seed for one or more hash functions can be changed.

After selecting new parameters, the method is repeated, and a utilization value is calculated and determined to be acceptable. If the utilization value (C) is acceptable (step 10308, yes), the current parameters are used to start building the hash table at step 10312. If there is an overflow during construction (step 10314, yes), the parameters are changed at step 10310. If there is no overflow during construction (step 10314, no; step 10316, no), then when the build is complete (step 10316, yes) the table can be used at step 10318.

Optionally, a ratio of the number of unique keys to a number of elements (NE) in the hash table is evaluated with respect to a predetermined filling ratio threshold. During the determination step 10308 the ratio of the number of unique keys to be inserted to the number of elements may be evaluated as acceptable (the ratio of the number of unique keys to be inserted to the number of elements is greater than or equal to the predetermined filling ratio threshold) alongside the utilization value (C). If the utilization value and the ratio of the number of unique keys to be inserted to the number of elements are not acceptable, parameters 10310 are modified and a new utilization value is calculated. After selecting new parameters, the method is repeated, and a utilization value and a ratio of the number of unique keys to be inserted to a number of elements are calculated and determined to be acceptable. If the utilization value (C) and the ratio of the number of unique keys to the number of elements are acceptable (step 10308, yes), the current parameters are used to start building the hash table at step 10312.

The hash table may be used only for lookups. Alternatively, inserts may be allowed. In this case, the insert should be monitored 10320, and if there is an overflow, the parameters may be changed (step 10310), and a “re-hash” done (rebuild the hash table).

At retrieve, each pointer (from each hash function [Hᵢ] is used to search both of the buckets, preferably in parallel, for the key. Implementations are particularly useful for “DoesExist” and “InList” queries. Alternatively, and/or in addition, KV entries may be associated with corresponding data.

In an embodiment, a system for generating a hash table comprises a plurality of buckets configured to receive a number of unique keys, the system comprising: at least one processing unit configured to: determine an initial set of hash table parameters; determine, based on the initial set of hash table parameters, a utilization value that results in a predicted probability of an overflow event being less than or equal to a predetermined overflow probability threshold; build the hash table according to the initial set of hash table parameters, if the utilization value is greater than or equal to the number of unique keys; and if the utilization value is less than the number of unique keys, then change one or more parameters of the initial set of hash table parameters to provide an updated set of hash table parameters that result in the utilization value being greater than or equal to the number of unique keys and build the hash table according to the updated set of hash table parameters.

In some embodiments, the initial set of hash table parameters includes one or more of a number of buckets, a bucket size, and a number of choices. In some embodiments, the initial set of hash table parameters further includes at least one of a size of each of the unique keys, a number of hash functions, one or more hash function seeds, an available memory from a memory storage unit, an element size or a combination thereof.

In some embodiments, the utilization value is based on an asymptotic balanced formula applied to the initial set of hash table parameters.

In some embodiments, building the hash table according to the initial set of hash table parameters occurs when a ratio of the number of unique keys to a number of elements allocated for the hash table is greater than or equal to a predetermined filling ratio threshold value; and wherein building the hash table according to the updated set of hash table parameters occurs when a ratio of the number of unique keys to the number of elements allocated for the hash table is less than the predetermined filling ratio threshold value, and wherein changing the one or more parameters of the initial set of hash table parameters to provide the updated set of hash table parameters further results in the ratio of the number of unique keys to the number of elements allocated for the hash table being greater than or equal to the predetermined filling ratio threshold value.

In some embodiments, the number of elements allocated for the hash table is equal to a number of buckets multiplied by a bucket size, and the number of elements is greater than or equal to the number of unique keys to insert into the hash table.

In some embodiments, the predicted probability of the overflow event is determined based at least in part on the initial set of hash table parameters. For example, the predetermined overflow probability threshold may be greater than or equal to 0%, less than 10%, or at least 80%.

In some embodiments, the processing unit is an accelerator processor. In some embodiments, the hash table is stored in a memory storage unit. In some embodiments, the memory storage unit is internal to the system. In some embodiments, the memory storage unit is external to the system.

In some embodiments, the at least one processing unit is further configured to: detect an overflow event; in response to the detected overflow event, change one or more parameters of the initial or updated set of hash table parameters used to build the hash table to provide a refined set of hash table parameters; and re-build the hash table using the refined set of hash table parameters.

In some embodiments, the refined set of hash table parameters includes more buckets than a number of buckets associated with the initial or updated set of hash table parameters. In some embodiments, the refined set of hash table parameters includes a bucket size greater than a bucket size associated with the initial or updated set of hash table parameters. In some embodiments, the refined set of hash table parameters includes a number of choices greater than a number of choices associated with the initial or updated set of hash table parameters.

In some embodiments, detecting the overflow event occurs during the building of the hash table or during an operation performed on the hash table.

In some embodiments, after providing the refined set of hash table parameters, the at least one processing unit is further configured to: determine, based on the refined set of hash table parameters, a new utilization value that results in a new predicted probability of a new overflow event being less than or equal to the predetermined overflow probability threshold; and verify that the new utilization value is greater than or equal to a number of unique keys before re-building the hash table using the refined set of hash table parameters.

### Engine For High Performance Key-Value Processing

Key Value Engine: Microprocessor with Architectural Blocks to Perform Tasks in Parallel

An innovative hardware engine may include pipelined multi-threading to process key value (“KV”) tasks (also known as “flows”) using a microprocessor that includes a function-specific architecture. Multi-threading may optimize CPU usage by sharing diverse core resources of a processor by a plurality of threads. In contrast, the disclosed embodiments of the present disclosure may optimize memory accesses by managing memory bandwidth. For example, the engine may multi-thread two or more KV tasks (e.g., build, lookup, exist, etc., not necessarily the same type of tasks). That is, the engine may assign each task to a particular thread such that the tasks may be executed in parallel. The threads may be pipelined to align engine processing of each thread with the availability of a corresponding memory access (e.g., writing/data ready to be written or reading/data has been returned from memory). The pipeline may be used to prepare the engine ahead of a memory access such that during a memory access time slot (also referred to in this description as a “memory access time” or a “memory access opportunity”), the engine may use a single clock cycle to process the thread.

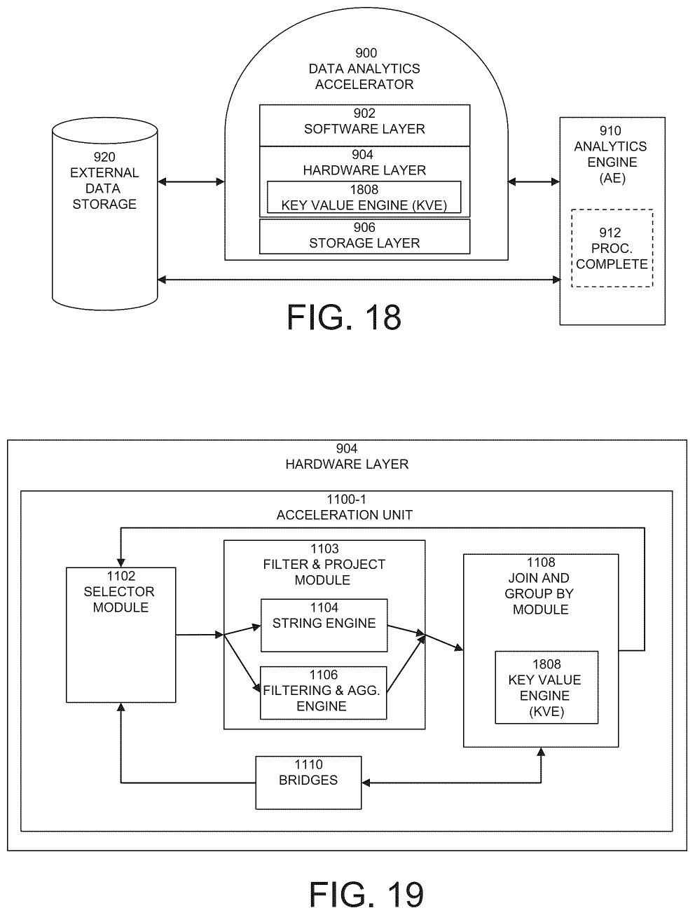

FIG. 18 is a high-level example of a data analytics architecture. Acceleration, such as the data analytics accelerator 900, can be done at least in part by applying innovative operations between the external data storage 920 and the analytics engine 910 (e.g., a CPU), optionally followed by completion processing 912. Optimizing memory access enables efficient operations and can correspondingly speed up various processes. The key value engine (KVE) 1808 may be implemented as a module in the hardware layer 904.

FIG. 19 is an example of the data analytics accelerator 900 hardware layer 904 including implementation in the acceleration unit 1100 of the join and group by module 1108 with embodiments of the key value engine (KVE) 1808. As described elsewhere in this document in reference to the acceleration architecture and configuration, the KVE 1808, as a portion of the join and group by module 1108 can be configured to receive inputs from any of the other acceleration elements, such as the filtering and projection module (FPE) 1103 and optionally, alternatively or additionally, from one of the bridges 1110. Similarly, the KVE 1808 can be configured to output to any of the other acceleration elements, for instance to the selector module 1102 and to the bridges 1110.

Note, in the current figure, output from the KVE 1808 is shown in an exemplary, non-limiting, configuration as feedback to the selector module 1102. However, as described elsewhere in this disclosure, this configuration is not limiting and the KVE 1808 may provide feedback to any module in the acceleration unit 1100 or via the bridges 1110 to other system elements. In the context of this disclosure, the KVE 1808 is also referred to as the “engine” 1808.

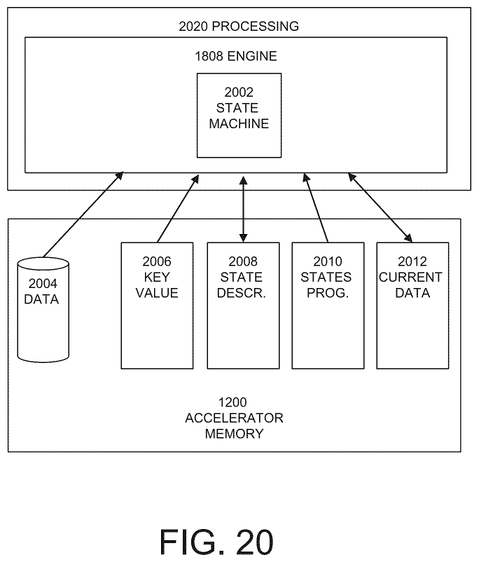

FIG. 20 is a high-level example of exemplary components and configuration of the KVE. Engine 1808 may be implemented in the hardware layer 904 as part of a hardware processing module 924, shown in the current figure as processing 2020. Engine 1808 may include multiple blocks (modules), for example, a state machine 2002. Engine 1808 may communicate with the accelerator memory 1200 that may be implemented locally or attached to the engine 1808, using for example internal field-programmable gate array (FPGA) memory, DRAMs, HBM, processing in memory (PIM), or XRAM memory processing modules (MPM).

The accelerator memory 1200 may be used to store data (2004, for example, a table), a key-value pair 2006, a state descriptor (2008 of the state of the state machine), a states program (2010 defining the operation of the state machine), and current data (2012 data to be written to memory or data that has been read from memory, e.g., a bucket header, key from memory, value from memory).

A feature of engine 1808 is performing processing based on the state descriptor 2008, the states program 2010, and the current data 2012. The engine 1808 may be prepared using the state descriptor 2008 of what state the engine 1808 (for example, the programmable state machine 2002) was in during the last processing turn and the states program 2010 of what operations and/or state transitions are available during the memory access time (2110, described elsewhere). During the memory access time slot 2110, the engine 1808 may use the current data 2012 to determine the next state and corresponding operations to perform. The state may then be updated, and memory read/write initiated as appropriate, preferably all in a single clock cycle. The new state may be stored as a new state descriptor 2008 and working data may be stored as new current data 2012, as appropriate. Then the engine 1808, already prepared in parallel by the pipeline with a next thread, on the next clock cycle, may process the next thread, while in parallel the previous thread's memory access proceeds.

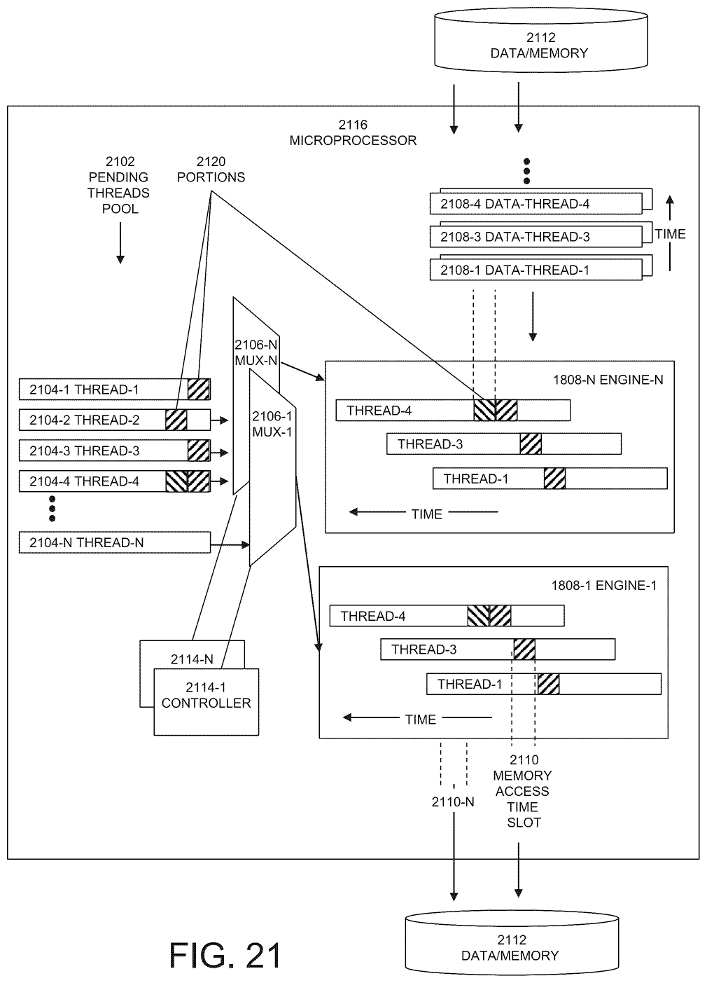

FIG. 21 is a diagram of an exemplary thread operation. In a non-limiting example, a pending threads pool 2102 includes threads 2404. Exemplary threads 1 to N are shown thread-1 2404-1, thread-2 2104-2, thread-3 2104-3, thread-4 2104-4, and thread-n 2104-n. Each thread may include one or more portions 2120 (for example, opcodes) that write data to memory or read/use data that has been returned from memory. Portions are shown as diagonal striped sub-elements of each thread. Note that for clarity, not all the portions are noted with an element number. Different multiplexer modules (mux 2106-1 through 2106-N) operated by controllers (2114-1 through 2114-N) may be used to send a pending thread 2104 to the different engines (1808-1 through 1808-N). In some embodiments, each engine may be customized to perform a certain type of operation (e.g., reading or writing data). Selection of a thread 2104 by a multiplexer module may be based on the thread 2404 requiring access to memory for writing data, or the availability of thread data 2108 that has been returned from memory (data 2112). Exemplary thread data 2108 are shown data-thread-1 2108-1 returns from memory first, then data-thread-3 2108-3, and last data-thread-4 2108-4. Reading data may take various lengths of time, depending on the specifics of the data 2112 to be read, how the data is stored, etc., which may result in data being available out of order from which the data read was executed. Multiple threads 2104 may be pipelined in an engine to align engine processing of each thread 2104 with the availability of a corresponding memory access time 2110. In the current example, as the data-thread-1 2108-1 returns from memory first, thread-1 is given first access to the memory access timeslot 2110. Then the data-thread-3 is ready, so the thread-3 is given access to the memory access timeslot 2110. And lastly, the data-thread-4 is returned and ready, so the thread-4 is selected for next access to the memory access timeslot 2110.

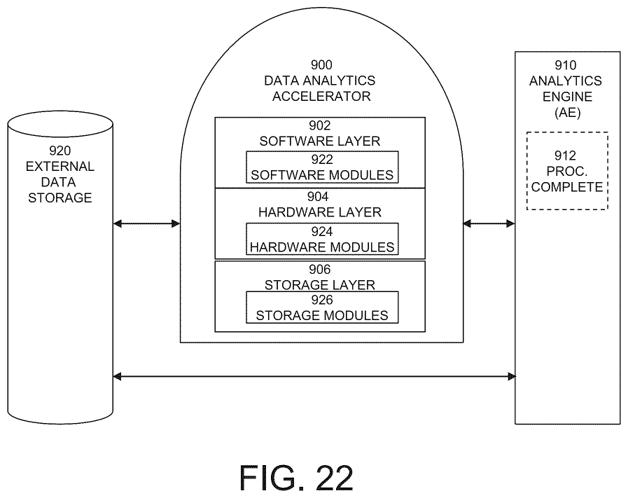

Consistent with the disclosed embodiments, the KV engine may be implemented using a microprocessor 2016 including a function-specific architecture. In some embodiments, microprocessor 2016 may comprise an interface configured to communicate with an external memory (such as data memory 2112) via at least one memory channel; a first architecture block configured to perform a first task associated with a thread; a second architecture block configured to perform a second task associated with the thread, wherein the second task includes a memory access via the at least one memory channel; and a third architecture block configured to perform a third task associated with the thread, wherein the first architecture block, the second architecture block, and the third architecture block are configured to operate in parallel such that the first task, the second task, and the third task are all completed during a single clock cycle associated with the microprocessor. Additionally, in some embodiments, the microprocessor may be a multi-threading microprocessor. A multi-threading microprocessor may comprise single or multiple cores. In some embodiments, the microprocessor may be included as part of a hardware layer of a data analytics accelerator. For example, as illustrated in FIGS. 18 and 22, the microprocessor may be included in the hardware layer 904.

In the context of this disclosure, an architecture block may refer to any type of processing system included in a microprocessor capable of performing tasks associated with a thread. Examples of an architecture block may include arithmetic and logic units, registers, caches, transistors, or a combination thereof. In some embodiments, the first architecture block, the second architecture block, or the third architecture block may be implemented using a field programmable gate array. For example, the different architecture blocks may be implemented on a plurality of programmable logic blocks comprised in an FPGA. In some other embodiments, the first architecture block, the second architecture block, or the third architecture block may be implemented using a programmable state machine, wherein the programmable state machine has an associated context, and the state machine context is stored. For instance, as illustrated in FIG. 20, KVE may comprise a state machine 2002. This state machine has an associated context comprising for example state descriptor 2008, states program 2010, and current data 2012, reflecting the current condition of the state machine.

Referring to FIG. 21, any of the engines 1808 through 1808-N may include a first architecture block, a second architecture block and a third architecture block as described above, or a plurality of engines may share a first architecture block, a second architecture block and a third architecture block as described above. In some embodiments, the microprocessor may include a multitude of additional architecture blocks. For example, any of the engines 1808 through 1808-N may include a first architecture block, a second architecture block and a third architecture block and one or more architectures blocks.

In the context of this disclosure, a thread may refer to an instruction stream and an associated state known as context. In some embodiments, a thread may include one or more instructions requiring memory access. Threads may be interrupted, and when such an interruption occurs, the current context of the running thread should be saved in order to be restored later. To accomplishing this, the thread may be suspended and then resumed after the current context has been saved. Accordingly, a thread context may include various information a thread may need to resume execution smoothly, such as for example a state descriptor 2008 of the state of the state machine. The context of a thread may be stored in one or more registers, internal memory, external memory or any other suitable system capable of storing data.

As discussed above, the first architecture block may be configured to perform a first task associated with a thread. In some embodiments, the first task may include a thread context restore operation. A thread context restore operation may refer to loading the saved thread context. As discussed above, the third architecture block may be configured to perform a third task associated with the thread. In some embodiments, the third task may include a thread context store operation. A thread context store operation may refer to saving the current thread context.

Switching from one thread to another thread may involve storing the context of the current thread and restoring the context of another thread. This process is often referred to as a context switch. A context switch may significantly impact a system's performance since the system is not doing useful work while switching among threads. In contrast, the disclosed embodiments of the present disclosure provide an engine that perform context switching and memory access operations in a single clock cycle.

As discussed above, the second task may include a memory access via the at least one memory channel. In some embodiments, the memory access of the second task may be a READ or a WRITE operation. For example, a thread may include an instruction specifying to READ a particular data item from memory or to WRITE a particular data item to memory. Note that various related operations may correspond to the memory access of the second task, including operations such as DELETE, CREATE, REPLACE, MERGE or any other operation involving the manipulation of data stored in the memory. Consequently, different scenarios related to the operation of the first architecture block, the second architecture block and the third architecture block are possible.

In some embodiments, during a first clock cycle associated with the microprocessor and for a first retrieved thread: a thread context restore operation may be performed by the first architecture block, a memory access operation may performed by the second architecture block, and a thread context store operation may be performed by the third architecture block; during a second clock cycle associated with the microprocessor and for a second retrieved thread, wherein the second clock cycle immediately follows the first clock cycle, a thread context restore operation may be performed by the first architecture block, a memory access operation may be performed by the second architecture block, and a thread context store operation may be performed by the third architecture bloc; and wherein the memory access operation performed by the second architecture block during the first or second clock cycle is either a READ or a WRITE operation.

For example, during a first clock cycle associated with the microprocessor and for a first retrieved thread: a thread context restore operation may be performed by the first architecture block, a READ memory access operation may be performed by the second architecture block, and a thread context store operation may be performed by the third architecture block; and during a second clock cycle associated with the microprocessor and for a second retrieved thread, wherein the second clock cycle immediately follows the first clock cycle, a thread context restore operation may be performed by the first architecture block, a READ memory access operation may be performed by the second architecture block, and a thread context store operation may be performed by the third architecture block. This situation corresponds to fast context switching between different threads and sequential reads. Referring to FIG. 21, these two-consecutive series of operations may be performed by the same engine (e.g., engine 1808) or two different engines (e.g., engine 1808 and engine 1808-N).

In another example, during a first clock cycle associated with the microprocessor and for a first retrieved thread: a thread context restore operation may be performed by the first architecture block, a WRITE memory access operation may be performed by the second architecture block, and a thread context store operation may be performed by the third architecture block; and during a second clock cycle associated with the microprocessor and for a second retrieved thread, wherein the second clock cycle immediately follows the first clock cycle, a thread context restore operation may be performed by the first architecture block, a WRITE memory access operation may be performed by the second architecture block, and a thread context store operation may be performed by the third architecture block. This situation corresponds to fast context switching between different threads and sequential writes. Referring to FIG. 21, these two consecutive series of operations may be performed by the same engine (e.g., engine 1808) or two different engines (e.g., engine 1808 and engine 1808-N).

In yet another example, during a first clock cycle associated with the microprocessor and for a first retrieved thread: a thread context restore operation may be performed by the first architecture block, a READ memory access operation may be performed by the second architecture block, and a thread context store operation may be performed by the third architecture block; and during a second clock cycle associated with the microprocessor and for a second retrieved thread, wherein the second clock cycle immediately follows the first clock cycle, a thread context restore operation may be performed by the first architecture block, a WRITE memory access operation may be performed by the second architecture block, and a thread context store operation may be performed by the third architecture block. This situation corresponds to fast context switching between different threads and alternating reads and writes. Referring to FIG. 21, these two consecutive series of operations may be performed on two different engines (e.g., engine 1808 and engine 1808-N). Alternatively, or additionally, in some embodiments, the second architecture block may include a first segment configured to perform a READ memory access and a second segment configured to perform a WRITE memory access. For example, the two consecutive series of operations mentioned above may be performed by the same engine (e.g., engine 1808) or by two different engines sharing a same second architecture block. Note that the READ and WRITE operations may be exchanged in the previous embodiment.

In some embodiments, the second architecture block may be configured to perform a READ memory access via the at least one memory channel, and the microprocessor may further comprise a fourth architecture block configured to perform a WRITE memory access via the at least one memory channel. In this situation, READ and WRITE operations are performed by different architecture blocks (second and fourth). Referring to FIG. 21, any of the engines 1808 through 1808-N may include a first architecture block, a third architecture block and at least one of a second architecture block, a fourth architecture block as described above, or a combination thereof. Note that the READ and WRITE operations may be exchanged in the previous embodiment.

In some embodiments, during a first clock cycle associated with the microprocessor and for a first retrieved thread: a thread context restore operation may be performed by the first architecture block, a READ memory access operation may be performed by the second architecture block, and a thread context store operation is performed by the third architecture block; and during a second clock cycle associated with the microprocessor and for a second retrieved thread, wherein the second clock cycle immediately follows the first clock cycle, a WRITE memory access operation is performed by the fourth architecture block. This situation corresponds to fast context switching between different threads and alternating reads and writes. Referring to FIG. 21, these two-consecutive series of operations may be performed by the same engine (e.g., engine 1808) or by two different engines (e.g., engine 1808 and engine 1808-N). Note that the READ and WRITE operations may be exchanged in the previous embodiment.

In some embodiments, the microprocessor may further comprise a fourth architecture block configured to execute, during the single clock cycle, a data operation relative to data received as a result of an earlier completed READ request. This situation may occur when a thread includes instructions that do not require a WRITE operation. A piece of data received as a result of a previous READ operation may need additional processing. For example, a filtering operation may be required, this operation does not involve a WRITE operation. Alternatively or additionally, the data operation may include generation of a READ request specifying a second memory location different from a first memory location associated with the earlier completed READ request. For example, a previous READ operation may have indicated that a first memory location is full, so before writing data, a second READ operation at a second memory location may be necessary to verify available storage, the data operation therefore corresponds to the generation of this second READ request. In another example, the first memory location may be associated with a first hash table bucket header, and the second memory location may be associated with a second hash table bucket header different from the first hash table bucket header.

As discussed above, a different thread may be retrieved before execution or context switching. In some embodiments, the microprocessor further comprises one or more controllers and associated multiplexers configured to select the thread from at least one thread stack including a plurality of pending threads. For example, as illustrated in FIG. 21, different multiplexers (2106-1 through 2106-N) operated by controllers (2114-1 through 2114-N) are employed to select threads from a pending threads pool 2102 including a plurality of pending threads.

In some embodiments, the one or more controllers and associated multiplexers may be configured to select the thread from the at least one stack based on a first-in-first-out (FIFO) priority. For example, as illustrated in FIG. 21, if thread-1 2101-1 arrived at the pending threads pool 2102 before thread-2 2101-2, thread-1 2101-1 may be selected by controllers 2114 and multiplexers 2106 before thread-2 2101-2. In some embodiments, the one or more controllers and associated multiplexers may be configured to select the thread from the at least one stack based on a predetermined priority hierarchy. For example, certain threads may have priority over other threads, or some engines may take priority over READ requests in order to saturate the memory bandwidth.

In some embodiments, the at least one thread stack may include a first thread stack associated with thread read requests and a second thread stack associated with thread data returned from earlier thread read requests. For example, in FIG. 21 a second thread stack 2108 is shown corresponding to thread data returned from earlier thread requests. Additionally, in some embodiments, the thread data returned from earlier thread read requests may be tagged to identify a thread to which the thread data belongs. As illustrated in FIG. 21, each thread data returned from the memory may be tagged to identify a corresponding thread, this way data-thread-1 2108-1 (with tag value 1) belongs to thread-1 2101-1, data-thread, data-thread-3 2108-3 (with tag value 3) belongs to thread-3 2101-3 and data-thread-4 2108-4 (with tag value 4) belongs to thread-4 2101-4. In some embodiments, the one or more controllers and associated multiplexers may be configured to select the thread based on tag values associated with the thread data returned from the earlier thread read requests. For example, referring to FIG. 21, as data-thread-1 2108-1 returns from memory first, controllers 2114 and multiplexers 2106 may select thread-1 from the pending threads pool 2102 before other threads.

In some embodiments, the one or more controllers and associated multiplexers may be configured to cause alignment of a first memory access operation, associated with a first thread and occurring during a first clock cycle, with a second memory access operation, associated with a second thread and occurring during a second clock cycle adjacent to the first clock cycle, wherein the first and second memory access operation is either a READ or a WRITE operation. In order to maximize memory bandwidth utilization, as many memory access operations as possible should be executed during consecutive clock cycles. Therefore, the memory access operations of different threads can be pipelined so that the at least one memory channel is used and so READ and WRITE operations of two different threads can be scheduled in two consecutive clock cycles. Note that in some other embodiments, two READ operations or two WRITE operations, or a WRITE operation and a READ operation from two different threads, may be scheduled in the above manner. In some embodiments, if a memory access operation is a READ operation, the one or more controllers may receive an indication that data corresponding to the READ operation has been returned from memory. In other embodiments, e.g., where the block architectures are implemented using a state machine, the one or more controllers may include a description of the thread context within the state machine.

In some other embodiments, at least one of the first task or the third task may be associated with maintenance of a context associated with the thread. Maintenance of a thread context may refer to a thread context store operation or a thread context restore operation. Additionally, in some embodiments, the context may specify a state of a thread. For example, the state of a thread may correspond to “new” if the thread has just been created, “terminated” if the instructions have been entirely executed, “ready” if all the elements to run the thread are available, or “waiting” if there is a timeout or some data required by the thread are not available. In some other embodiments, the context may specify a particular memory location to be read. For example, when a thread is new, the context may include an indication of the memory location to be read to retrieve the data necessary to execute the thread. In yet another embodiment, the context may specify a function to execute. The function to execute may refer to any type of operation in relation to the thread. In some embodiments, the function to execute may be a memory READ associated with a particular hash table bucket value. In another embodiment, the function to execute may be a read-modify-write operation.

In some embodiments, the at least one memory channel comprises two or more memory channels. The bandwidth of these memory channels may be different or the same. For example, communication between the interface and the external memory 2112 may be provided by 2, 4, 6, or any other appropriate number of identical memory channels. Additionally, in some embodiments, the two or more memory channels may be configured to support both a WRITE memory access and a READ memory access during the single clock cycle associated with the microprocessor. Further, in some embodiments, the WRITE memory access and the READ memory access may be associated with different threads.

In some embodiments, the microprocessor includes a fourth architecture block configured to perform a fourth task associated with a second thread; a fifth architecture block configured to perform a fifth task associated with the second thread, wherein the fifth task includes a memory access via the at least one memory channel; and a sixth architecture block configured to perform a sixth task associated with the second thread, wherein the fourth architecture block, the fifth architecture block, and the sixth architecture block are configured to operate in parallel such that the fourth task, the fifth task, and the sixth task are all completed during a single clock cycle associated with the microprocessor. Referring to FIG. 21, a first engine (e.g., engine 1808) may comprise the first architecture block, the second architecture and the third architecture block, and a second engine (e.g., engine 1808-N) may comprise the fourth architecture block, the fifth architecture block and the sixth architecture block. The fourth architecture block, the fifth architecture block, and the sixth architecture block may be composed of the same or of a different type of processing system/hardware component used to implement the first architecture block, the second architecture block, and the third architecture block.

Additionally, in some embodiments, during a first clock cycle associated with the microprocessor and for a first retrieved thread: a thread context restore operation may be performed by the first architecture block, a memory access operation may be performed by the second architecture block, and a thread context store operation may be performed by the third architecture block. During the first clock cycle associated with the microprocessor and for a second retrieved thread, a thread context restore operation may be performed by the fourth architecture block, a memory access operation may be performed by the fifth architecture block, and a thread context store operation may be performed by the sixth architecture block. The memory access operation performed by the second architecture block and the memory access operation performed by the fifth architecture block during the first clock cycle may be either a READ operation or a WRITE operation. In such a situation, parallel READ or WRITE operations associated with two or more threads are possible. For example, a first engine comprising the first architecture block, the second architecture block and the first architecture block, may perform a READ operation comprised in a first thread using a first memory channel during a single clock cycle, and a second engine comprising the fourth architecture block, the fifth architecture block and the sixth architecture block, may perform in parallel a WRITE operation comprised in a second thread using a second memory channel during the same single clock cycle.

In some embodiments, the first task, the second task, and the third task may be associated with a key value operation. Examples of key-value operations may include fetching, deleting, setting, updating, or replacing a value associated with a given key.

In some embodiments, the microprocessor may be a pipelined processor configured to coordinate pipelined operations on a plurality of threads by context switching among the plurality of threads. For example, the plurality of threads may include at least 2, 4, 10, 16, 32, 64, 128, 200, 256 or 500 threads. Fast context switching between each thread of a plurality of threads in a single clock cycle can enable pipelined processing of many different threads. This feature is in contrast to CPUs where context switching is a slow operation. Standard CPUs can handle a few threads (e.g., 4 or 8) at a time, but do not have enough cores to handle many threads (e.g., 64) at a time.

Although the disclosed embodiments are particularly useful for accelerating processing of key value flows, as in the current description, this is not limiting. Based on the current description, one skilled in the art will be able to design and implement embodiments of the architecture and method for other tasks and flows.

### Reduction of Routing Congestion

A system for routing configures a channel through a given connection layer, while a second connection layer provides a bypass of the channel and maintains continuity for the given connection layers is disclosed.

When routing and optimizing connections, there are limitations including placement of the route ends, physical connections, and how many layers of connections can be used. Problems to be solved include, but are not limited to, eliminating or minimizing current drop from power sources to cells, and not overloading the maximum power (current and/or voltage) on one or more routes (power stripes). One example of the disclosed embodiments is a system for routing connections. Embodiments are particularly suited for implementation in integrated circuits (ICs). For example, placing cells and routing connections between cells.

FIG. 22 is an example diagram of architecture, consistent with disclosed embodiments. Data analytics acceleration 900 can be done at least in part by applying innovative operations between the external data storage 920 and the analytics engine 910 (e.g., a CPU), optionally followed by completion processing 912. The software layer 902 may include software processing modules 922, the hardware layer 904 may include hardware processing modules 924, and the storage layer 906 may include storage modules 926 such as the accelerator memory 1200.

Implementations of the routing system can be used in various locations, such as in the hardware layer 904 and in the storage layer 906. The disclosed system is particularly useful for processing in memory, such as the memory processing module 610.

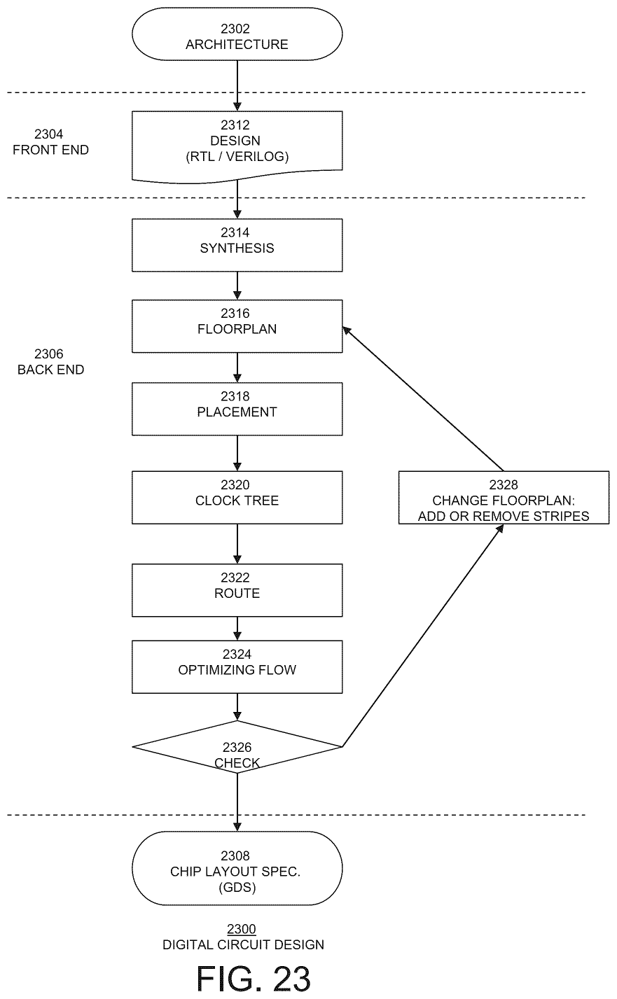

FIG. 23 is a flowchart of generating a chip construction specification, consistent with disclosed embodiments. A method 2300 for generating a chip construction specification (digital circuit design) may begin with an architecture 2302 specifying a plurality of features desired to be implemented by the chip. The architecture 2302 goes through a front-end process 2304, then a back-end process 2306 to generate a chip construction specification 2308.

The front-end process 2304 may include the architecture 2302 being coded, for example, into RTL design 2312. Common design implementations are at the register-transfer level (RTL) of abstraction, for example using Verilog (a hardware description language [HDL] standardized as IEEE 1364, used to model electronic systems). The design 2312 may then goes through multiple implementation stages such as synthesis 2314 (creating cells), floorplan 2316 (of the design including power distribution) which can set for the rest of the steps, placement 2318 (of cells/elements in proximity to other cells/elements), clock tree 2320 (generation), route 2322 (to cells as needed), and optimizing flow 2324. The output of the back end 2306 implementation stages is the chip layout specification 2308, for example a graphic data system (GDS) file that is sent for chip fabrication.

In current embodiments, an additional step of checking 2326 can be implemented. Where checking reveals conflicts, parameters can be changed and re-layout can be done 2328, returning to a step like floorplan of the design 2316 for re-generation of an updated chip layout specification.

As noted above, there are challenges of routing and optimizing connections between cells to be able to include all of the desired features on a chip. Solutions to this problem include adding additional connection layers, for example additional metal layers to the chip. When constructing computational chips, 7 (seven) or more layers are used to provide all the necessary connections between cells. If additional connections are required, additional layers can be added to the chip and 10 to 20 layers. Another solution is to increase the size of the chip, providing more area for layout of the cells, locating/positioning cells, and physical connections between the cells. Another solution is to drop features. By removing desired features from a chip, there are less cells that need to be implemented and thus less connections between cells needed on the chip.

Without limiting the scope of the disclosed embodiments, for clarity, an embodiment is described using a memory IC chip implementation of a processing in memory module, such as the XRAM computational memory (available from NeuroBlade Ltd., Tel Aviv, Israel).

A first problem is constructing a chip that includes both storage memory and computational (processing) elements. Computational elements may be constructed using computational chip technology having many connection layers, for example 7 or more layers. In contrast, memory elements may be constructed using memory chip technology having relatively few layers, for example a maximum of 4 (four) layers. If when constructing a chip using memory technology, and more connections are required than the given number of layers (for example, 4), additional layers cannot be added to the chip, so the solution of adding layers will not solve this problem.

A second problem is that a memory chip may be deployed on a standard DIMM (dual in-line memory module, RAM stick). As there is a standard size for DIMM chips, if this standard size is not sufficient for the required connections, the size (area) of the chip cannot be increased, so the solution of increasing the size of the chip will not solve this problem.

A third problem that arises from this implementation is that a processing in memory chip may have a large number of features, as compared to a memory chip. All of the features are desired to be implemented, so the solution of dropping features will not solve this problem.

As noted above, embodiments are not limited to implementations with memory processing modules 610. It is foreseen that other applications, including but not limited to computational chips with increased complexity, memory chips with additional features, and similar, can benefit from embodiments of the current method and system for reduction of routing congestion.

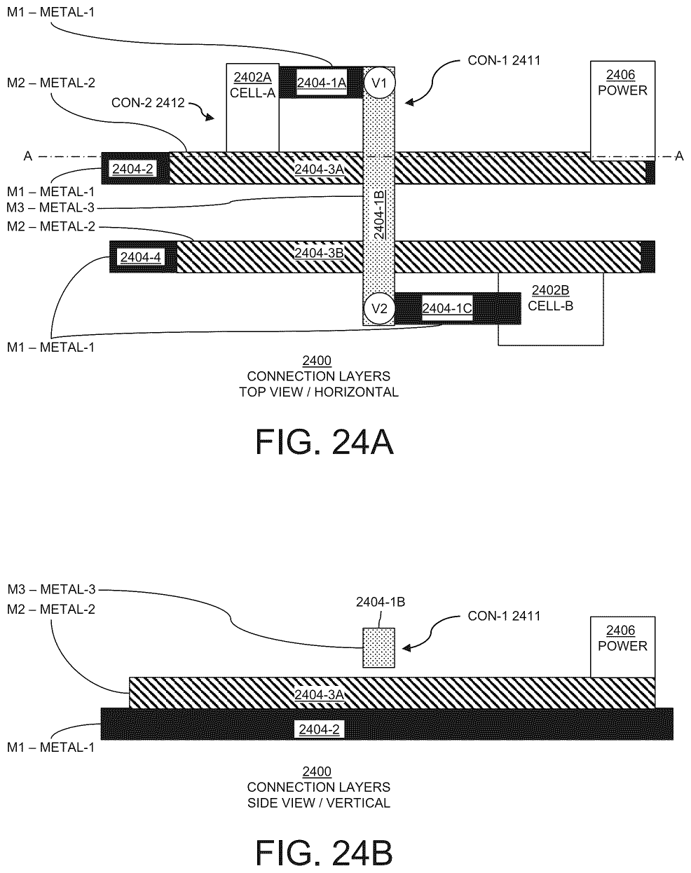

FIG. 24A is a drawing of connection layers from a top view, consistent with disclosed embodiments. FIG. 24B is a drawing of connection layers from a side view, consistent with disclosed embodiments. In the current figure of connection layers 2400, a non-limiting, exemplary case of using memory chip technology will be used. The FIG. 24A view is from above, looking down on the chip's connection layers, viewing the layers and segments horizontally. FIG. 24B view is from a side, at FIG. 24A line AA, looking in on the stack of the chip's connection layers, viewing the layers and segments vertically. Two exemplary cells 2402 are shown: A first cell 2402A and a second cell 2402B. One exemplary power source 2406 is shown. Three exemplary connection layers are shown: metal-1 M1 (black lines), metal-2 M2 (striped lines), and metal-3 M3 (spotted line).

One skilled in the art is aware that the terms “horizontal” and “vertical” are used in two different contexts: One context referring to a physical layout, for example of a chip, with horizontal layers stacked vertically with respect to the base (substrate of the chip), and a second context referring to design layout, for example how layers are drawn on a page with horizontal (left-right) and vertical (up-down) directions on the page.

Each connection layer is horizontal with respect to the base of the chip, shown in FIG. 24A as left-right and up-down on the page, and correspondingly in FIG. 24B as left-right on the page. Each connection layer is at a different vertical height with respect to the chip. The lowest layer, under the other layers is the metal-1 M1 layer, then the metal-2 M2 layer on top of the metal-1 M1 layer, then at the top, above the metal-2 M2 layer is the metal-3 M3 layer. A memory chip also may include a metal-4 M4 layer (not shown in the current figures) on top of the metal-3 M3 layer. Vertical vias Vn (where n is an integer representing different vias) connect one layer to another layer. In the current figure, via-1 V1 and via-2 V2 both provide connectivity between the metal-1 layer and the metal-3 layer. Connections (segments, line segments, portions, portions of conductive lines) in each layer are designated in the drawings with metal-1 segments 2404-1n, 2404-2n, 2404-4n, 2504-2n and metal-2 M2 segments 2404-3n, where n is an integer or letter designating different segments. References such as 2404-2, 2404-4, 2504-2, and 2404-3 are to the layer in general.

In the context of this description, the terms “segments” and “line segments” generally refer to an area of a route, a length of the route between two or more elements, for example in a single direction, but this is not limiting, and segments and line segments may include lengths in more than one direction of routes. In the context of this document, the terms “portion” and “portions of (conductive) lines” generally refer to an area of a segment, for example, where two or more segments are operationally connected. In the context of this document, the term “connection” may include reference to segments, line segments, portions, portions of conductive lines, and similar, as will be obvious to one skilled in the art.

Each layer may be a single material, that is, portions (segments) of connections in each layer are constructed of the same material. References to materials for each layer are normally references to the material used for connections in each layer. In the current case, connections are electrically conductive. Each layer may contain at least another material to separate between the connections in the layer (not shown), in this case the other material is electrically insulating. In addition, another material (not shown, which can be the other material) is also used between the layers to provide separation between the connections of each layer, in this case the other material is electrically insulating.

Layers, in particular, but not limited to connections, may be formed in a single direction, known in the art as the direction of routing or the preferred routing direction. The preferred routing direction is dependent on the layer (for example, which metal is being used). The preferred routing direction of a given layer may be perpendicular to the preferred routing direction of adjacent (above and below) layers. For example, in the current figures the metal-2 layer has a preferred routing direction of left-right (as drawn on the page, also referred to in the field as horizontal) and the metal-3 layer will have a preferred routing direction of up-down (also referred to in the field as vertical). Within a layer, a direction other than the preferred routing direction, such as perpendicular to the preferred routing direction, is referred to as a non-preferred routing direction. Note that metal-1 and metal-2 may be constructed in the same direction, as is known in the art for cell connectivity.

Due to the properties of materials, the metal-1 layer may be a high (electrical) resistance material that is well-suited for connection to cells, while the metal-2 layer may be a low (electrical) resistance material that is well-suited for conduction. The metal-1 layer and the metal-2 layer are used in combination to provide both connection to cells and transmission between cells and other elements (signals, clock, power, ground, etc.). A construction includes using metal-1 to connect to a cell (a cell's one or more connections) and then coupling metal-1 to metal-2. Coupling can be done by a variety of means, for example such as constructing the metal-2 connections (lines) substantially exactly overlapping metal-1 and having vias (e.g., a multitude) along and between the metal-1 and metal-2 lines. Note, for clarity in the current figures, the metal-1 and metal-2 connections are not shown.

In the current exemplary case, there is a requirement to connect (route a connection) between the first cell 2402A and the second cell 2402B. The exemplary first connection (CON-1, 2411) starts with the first cell 2402A connected to a segment 2404-1A (a portion of the metal-1 layer, a connection portion, line segment) of metal-1 then using the first via V1 to connect to a segment 2404-1B of metal-3, then using the second via V2 to connect to a segment 2404-1C of metal-1, which then connects to the second cell 2402B. As can be seen in the current figure, using implementations requires two layers (metal-1 and metal-2) and two vias (V1, V2) to provide the connection (CON-1 2411) between the first 2402A and second 2402B cells.

The metal-1 segments 2404-2 and the metal-2 segments 2404-3 operate in combination, for example, to provide power from the power source 2406 to cells, and as part of a power grid supplying power to the chip/cells. A second connection (CON-2, 2412) is indicated using the segment 2404-2 of the metal-1 layer for providing power connection to the first cell 2402A. Note, in the perspective view of FIG. 24A the metal-1 segments 2404-2 and 2404-4 are not fully shown, as they are underneath and thus hidden by the respective metal-2 segments 2404-3A and 2404-3B.

In cases where certain solutions are not feasible, or not desirable, a solution is to create channels through given connection layers, while a second connection layer provides a bypass of the channel and maintaining continuity for the given connection layers. For example, connecting IC cells using one or more connecting layers, in particular using a smaller number of connecting layers (e.g., metal layers) are used, compared to other implementations. In a further example, using a channel facilitates routing between two cells using only a single metal layer, in place of two or more metal layers. Thus, reducing the use of two or more layers to using a single layer.

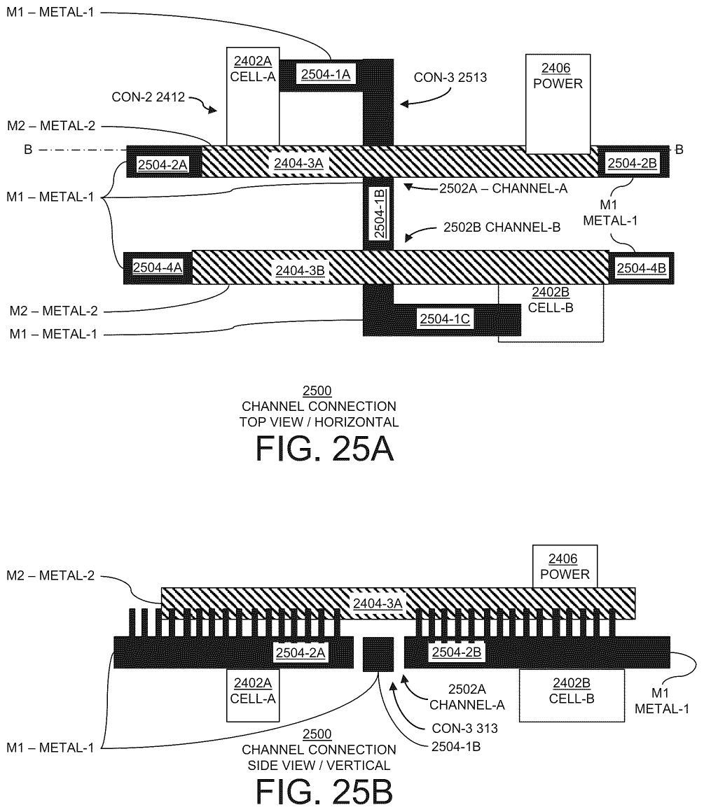

FIG. 25A is a drawing of a system for routing connections between cells from a top view, consistent with disclosed embodiments. FIG. 25B is a drawing of a system for routing connections between cells from a side view, consistent with disclosed embodiments. The current figure of a channel connection 2500 uses the same exemplary case of using memory chip technology as described in reference to FIG. 24A and FIG. 24B.

In contrast to the solution of the connection layers 2400 of FIG. 24A and FIG. 24B that uses vias (V1, V2) and multiple layers (M1, M3) for routing and connections, current embodiments use channels through a given layer, to allow a single layer to provide a connection, while a second connection layer provides a bypass of the channel and maintains continuity for the given connection layers. In the exemplary case of the current figures, a channel 2502 is created by the absence of metal-1, shown as two areas of the channel 2502, channel-A 2502A and channel-B 2502B. The channel-A 2502A is deployed by “breaking” the metal-1 segment 2404-2 into two segments: Segment 2504-2A and segment 2504-2B. One skilled in the art will realize that for the current case of an IC, the channel is formed by not depositing metal-1 (leaving an undeposited area) in the area of the desired channel. Similarly, the channel-B 2502B is deployed by “breaking” (not depositing) the metal-1 segment 2404-4 into two segments: Segment 2504-4A and segment 2504-4B.

Continuity of the connection previously provided by segment 2404-2, in this case providing power, is facilitated by the cooperative operation of the metal-2 segment 2404-3A with metal-1 segments 2504-2A and 2504-2B. The segment 2404-3A remains as described in regard to FIG. 24A and FIG. 24B, now bypassing the channel 2502 (specifically portion 2502A) of the metal-1 layer. Similarly, continuity of the connection previously provided by segment 2404-4, is facilitated by the cooperative operation of the metal-2 segment 2404-3B with metal-1 segments 2504-4A and 2504-4B. The segment 2404-3B remains as described in regard to FIG. 24 and FIG. 24B, now bypassing the channel 2502 (specifically portion 2502B) of the metal-1 layer.

Embodiments facilitate connection of the first cell 2402A and the second cell 2402B using a single layer, without using multiple layers, as described regarding the first connection (CON-1, 2411) of FIG. 24A. Instead, in the current figures, the first cell 2402A is connected via an exemplary third connection (CON-3, 2513) to the second cell 2402B. The third connection CON-3 is a single layer, in this case metal-1. For ease of description the third connection CON-3 is shown with a first portion 2504-1A connected to the first cell 2402A and then via a second portion 2504-1B to a third portion 2504-1C connecting to the second cell 2402B. The third connection CON-3 is routed (via the second portion/segment 2504-1B) through the channel 2502, staying in the metal-1 layer, and connecting (via segment 2504-1C) to the second cell 2402B.

In the current figures and example, the preferred routing direction of the metal-1 layer is left-right (horizontal) and the main segments 2504-2A (first segment) and 2504-2B (second segment) are correspondingly in the preferred routing direction, while a portion of the third connection CON-3, in this case the second portion 2504-1B is configured up-down (vertical) in a non-preferred routing direction for the metal-1 layer.

Embodiments are not limited to the current exemplary case of a single channel in a single layer. Multiple channels can be deployed in a single layer, two or more layers, or all layers. Similarly, corresponding multiple bypasses can be deployed in layers above or below the channels, using the same or different materials from the material of the layer of the channel. For example, a segment of metal-1 connectivity routing layer providing bypass continuity for segments from the metal-2 connectivity routing layer. In another example, the metal-4 layer can provide bypass for the metal-2 layer.

The sections below provide further examples and detail regarding operation of the current embodiment. In general, a system for routing includes a plurality of first layer routing segments including first (2504-2A), second (2504-2B), and third segments (2504-1B). One or more second layer routing segments including a bypass segment (2404-3A). A separation between the first and second segments is configured as a channel (2502A) for the third segment, and the bypass segment (2404-3A) configured for routing continuity between the first (2504-2A) and second (2504-2B) segments.

In an optional embodiment, the first and second routing segments are in a first direction and the third segment is in a second direction, the first direction being a direction other than the second direction. The first and second routing segments may be in a preferred routing direction and the third segment may be in a non-preferred routing direction, the non-preferred routing direction being a direction other than the preferred routing direction.

At least a portion of the third segment may be in a preferred routing direction. The non-preferred routing direction may be perpendicular to the preferred routing direction.

The first and second layer routing segments may each be a level of integrated circuit (IC) connections. The first layer routing segments may be IC metal-1 layer. The first layer routing segments may be a first conductive material. The first layer routing segments may be a high conductivity material. The second layer routing segments may be IC metal-2 layer. The second layer routing segments may be a second conductive material. The second layer routing segments may be a low conductivity material.

The third segment may be independent of the first and second segments. The third segment may be insulated from conductivity with the first and second segments. The third segment may be insulated from conductivity with the bypass segment.

The channel may be an isolation channel through the first layer, including an other material isolating (insulating) the third segment from the first and second segments. The other material may at least partially surround the third segment. The channel may provide transverse isolation of the first and second segments.

The bypass segment may be configured for electrical routing continuity between the first and second segments. The bypass segment may be configured for power distribution to with the first and second segments. The bypass segment may be configured for transfer of a signal other than a signal being transferred by the third segment.

The third segment may be configured for other than power distribution. The third segment may be configured for at least a portion of signal transfer between a first cell and a second cell. The first and second cells may be elements of an IC. The bypass segment, first segment, and second segment may be configured for cooperative operation providing routing continuity.

At least a first portion of the bypass segment may be substantially in contact with a portion of the first segment and at least a second portion of the bypass segment may be substantially in contact with a portion of the second segment.

The bypass segment may be coupled to the first segment by a first set of one or more vias. The bypass segment may be coupled to the second segment by a second set of one or more vias.

### Dynamic Grid Routing

A system for routing includes replacing one or more portions of one or more routes with one or more associated segments. Each of the segments independent from adjacent portions of the routes and each of the segments configured for communication of a signal other than a signal being communicated by each of the adjacent portions of the routes.

When routing and optimizing connections, there are limitations including placement of the route ends, physical connections, and how many layers of connections can be used. Problems to be solved include, but are not limited to, eliminating or minimizing current drop from power sources to cells, and not overloading the maximum power (current and/or voltage) on one or more routes (power stripes). One example of the disclosed embodiments is a system for routing connections. Embodiments are particularly suited for implementation in integrated circuits (ICs). For example, placing cells and routing connections between cells.

Refer again to FIG. 22, implementations of the current dynamic grid routing system can be used in various locations, such as in the hardware layer 904 and in the storage layer 906. The current method is particularly useful for processing in memory, such as the memory processing module 610.

Refer again to FIG. 23, FIG. 24A, and FIG. 24B and the corresponding descriptions for general implementations related to the current embodiments.

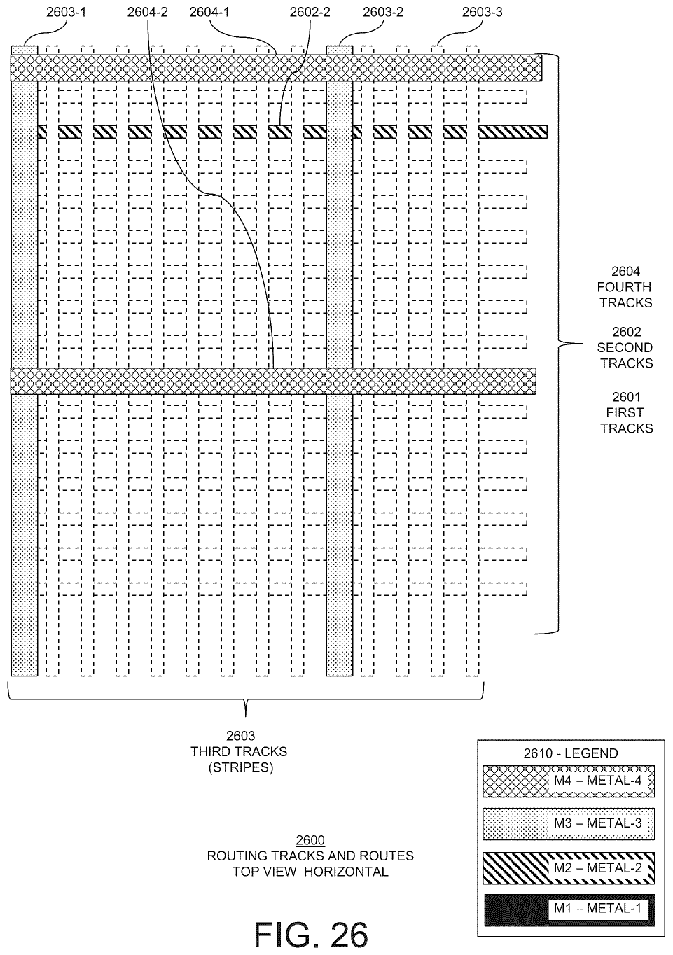

FIG. 26 is a diagram of routing tracks and routes 2600, for example, of an integrated circuit (IC), consistent with disclosed embodiments. While the current description generally uses examples of perpendicular layers of tracks, routing, and segments for an IC, this implementation is not limiting. The current figure is a view from on top of the IC, looking down at horizontal tracks with respect to the plane of the IC. In the context of this description, the term “routing tracks” generally refers to areas designated as available for implementing routes. Routing tracks are generally shown in the figures as dashed-outlined lines (boxes). Routing tracks are also referred to in the IC field as “stripes”, not to be confused with the use of “stripes” by some in the field to only refer to routes that are used for power. Routes can include various means of communication. For example, in an IC, routes of electrically conductive materials are used to carry signals such as power, ground, and/or data signals. Power and ground signals may be implemented with wider routes in comparison to the width of routes for carrying data signals. Routes can be in a single direction (for example, straight), two or more directions (for example, changing directions), one or more connection layers, one or more segments, one or more portions, and between two or more elements (for example, cells).

Four levels of tracks are shown, as designated in legend 2610: Metal-4 M4, metal-3 M3, metal-2 M2, and metal-1 M1. Each metal is drawn with a different fill pattern to assist in identifying the different metal routes in the figures. In this exemplary implementation, metal-4 (M4, fourth tracks 2604) tracks are drawn horizontally on the page, in this case wider and less frequent than the other tracks to implement carrying power (PWR, VDD) and ground (GND, VSS) signals. Two exemplary metal-4 routes (2604-1, 2604-2) are shown implemented. M3 (third tracks 2603) routing tracks are drawn vertically on the page, with two exemplary routes (2603-1, 2603-2) implemented, for carrying power or ground from connections from M4. M3 can also be used to carry data signals, for example shown as the vertical dashed boxes (for example track 2603-3) that are thinner in width than the M3 tracks (2603-1, 2603-2) carrying power or ground signals. Exemplary M2 (second tracks 2602) tracks are drawn horizontally on the page for carrying data signals. Exemplary M1 (first tracks 2601) tracks are drawn horizontally on the page for carrying data signals. As is known in the art, M1 routes may be implemented beneath M2 routes, and thus are “covered” and not visible in some figures. The number of layers may vary. For example, in a memory chip, only four layers may be used, while in a computational chip up to 17 or more layers may be used.

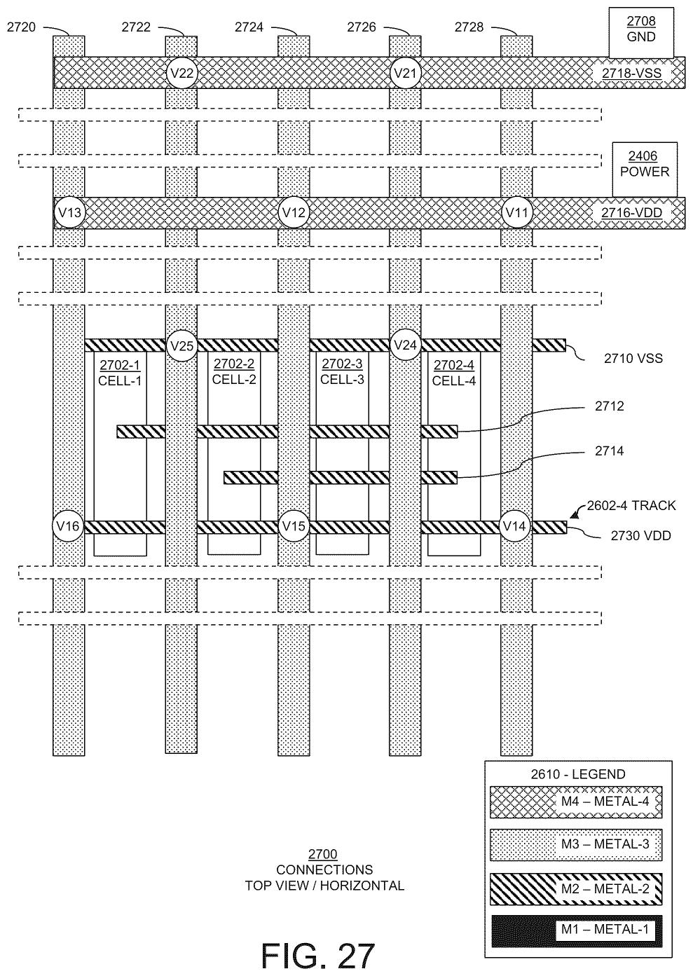

FIG. 27 is a diagram of connections 2700, for example, of an integrated circuit (IC), consistent with disclosed embodiments. The current figure is a view from on top of the exemplary IC, looking down at horizontal tracks with respect to the plane of the IC. The current figure builds on FIG. 26, adding exemplary implementations of routes for power, ground, and signaling to and between cells 2702. Specific cells are designated with element numbers 2702-n, where n is an integer. Cells 2702 are comparable to cells 2402.

A source of ground (2708, GND, ground connection, VSS) is operationally connected to M4 segment (route segment) 2718 VSS. The M4 segment 2718 is connected using vias V21 and V22 respectively to exemplary M3 segments 2726 and 2722. The M3 segments (2722, 2726) further connect VSS using vias V24 and V25 to M2 segment 2710 VSS. The M2 segment 2710 provides a VSS connection to cells 2702 (shown as exemplary cells cell-1 2702-1, cell-2 2702-2, cell-3 2702-3, and cell-4 2702-4).

Similar to the implementation of VSS, a source of power (2406, VDD) is operationally connected to M4 segment (route segment) 2716 VDD. The M4 segment 2716 is connected using vias V11, V12, and V13 respectively to exemplary M3 segments 2728, 2724, and 2720. The M3 segments (2728, 2724, 2720) further connect VDD using respective vias V14, V15 and V16 to M2 segment 2730 VDD. The M2 segment 2730, provides a VDD connection to cells 2702 (cell-1 2702-1, cell-2 2702-2, cell-3 2702-3, cell-4 2702-4). For reference, the M2 segment, or route, 2730 is implemented on routing track 2602-4.

An exemplary implementation will now be described to understand an exemplary problem with existing techniques, and assist with understanding an embodiment. In the current figure, a desired implementation is to connect each of cells cell-1, cell-2, and cell-3 to cell-4. Respectively between the VSS segments (2718, 2710) and VDD segments (2716, 2730) two routing tracks are available. A first routing track 2712 is used to implement a route connecting cell-1 to cell-4. A second routing track 2714 is used to implement a route connecting cell-2 to cell-4. As both routing tracks have been used, this technique fails to provide sufficient routes for connecting remaining cell-3 to cell-4.

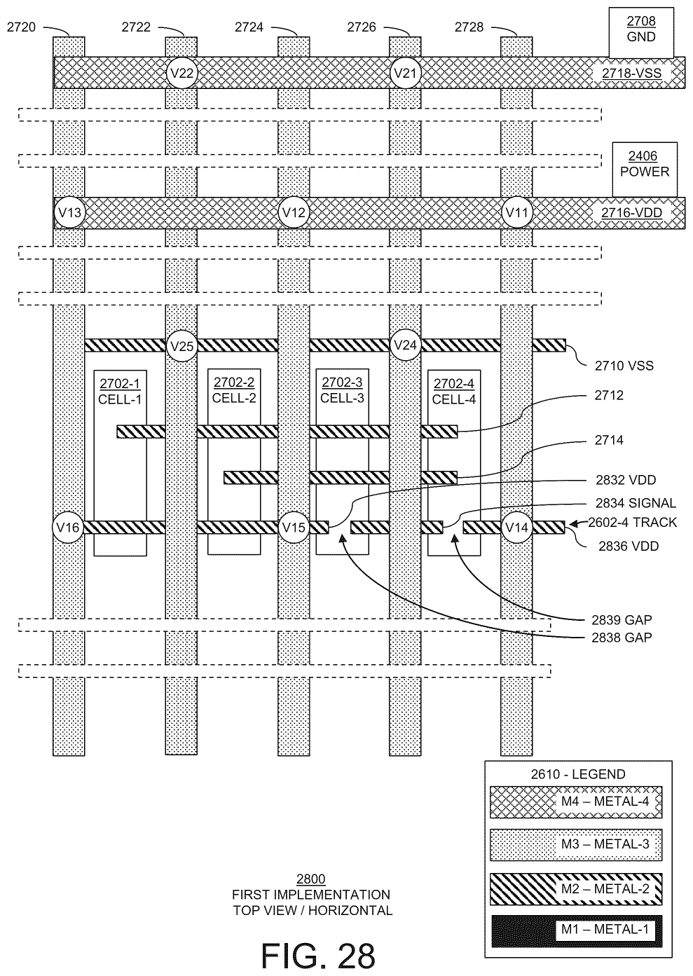

FIG. 28 is a diagram of a first implementation 2800, consistent with disclosed embodiments. The current figure builds on FIG. 27, continuing with a solution to the current exemplary problem. In general, a method for routing includes replacing one or more portions of one or more routes 2730 with one or more associated segments 2834. Each of the segments 2834 is independent (isolated, non-communicative, disjoined) from adjacent portions of the routes 2832, 2836. Each of the segments is configured for communication of a signal other than a signal being communicated by each of the adjacent portions of the routes. Corresponding to the current method, a system for routing includes one or more routing tracks 2602 having one or more associated segments 2834. Each of the segments independent (isolated, non-communicative, disjoined) from adjacent portions of routes (2832, 2836). Each of the segments 2834 is configured for communication of a signal other than a signal being communicated by each of the adjacent portions (2832, 2836).

From previous figures one of the second tracks 2602-4 having corresponding route 2730 VDD has had replaced a portion of the route 2730 in the current figure with the associated segment 2834. The associated segment 2834 is independent from the adjacent portions (2832, 2836). The associated segment 2834 is configured for communication of a data signal between cell-3 and cell-4, independent from communication of the VDD signal in the adjacent portions (2832, 2836). Previous route 2730 now includes gaps (2838, 2839) along the corresponding track 2602-4 facilitating re-use of the track 2602-4 for additional signal communication (data signal in addition to power). Cells remain in original locations, additional routing flexibility is gained (additional routes available), and other signal communication (power, VDD) is maintained.

In an optional implementation, each of the associated segments are substantially aligned with the routing tracks and/or of the replaced portion. In some implementations, each of the routes can be a power stripe or data signal routing of an integrated circuit (IC).

Each signal being communicated by each of the segments can be between two or more IC cells (e.g., data communication). Each signal being communicated by each of the routes can be distributed to one or more IC cells (e.g., power distribution). The signal being communicated by each of the routes can be power (e.g., VSS, VDD). Each of the routes can distribute the power to one or more IC cells. Each of the segments can be configured for communication of a data signal. Each of the data signals can be between two or more IC cells.

A feature is that distribution of the signal (e.g., power) being communicated by each of the routes is maintained during communication of each segment's signal (e.g., data).

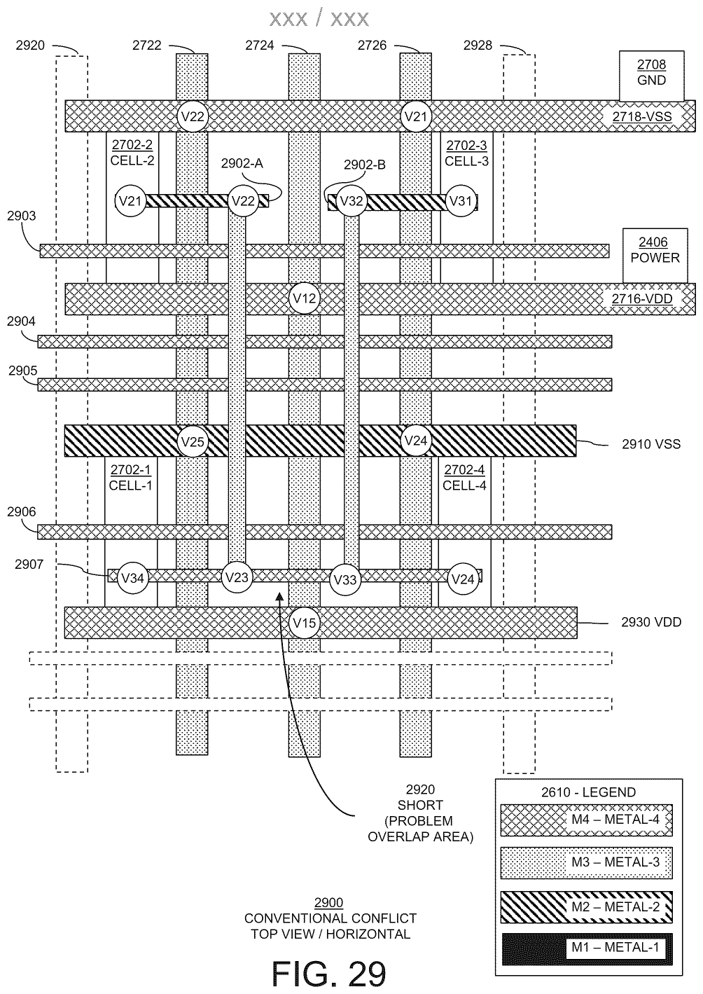

FIG. 29 is a diagram of a conflict of connections 2900, consistent with disclosed embodiments. In comparison with previous figures, the current figure lacks M3 routes 2720 and 2728, shown as respective routing tracks 2920 and 2928. Distribution of power from M4 route 2716 VDD uses only M3 route 2724 via V12. Power is further distributed from M3 2724 using via V15 and M4 route 2930. Note, in an embodiment, power is further distributed using M2, however M4 is an option, and is used in the current figure for clarity in the figures.

An exemplary implementation will now be described. In the current figure, a desired implementation is to connect between cell-1 and cell-3, and between cell-2 and cell-4. M4 routes 2903, 2904, 2905, and 2906 are already being used, so a proposed route is made to connect cell-1 using via V34 to M4 segment 2907, then via V33 to an M3 segment to via V32 to M2 segment 2902-B to via V31 to cell-3. A proposed route is also made to connect cell-4 using via V24 to M4 segment 2907, then via V23 to an M3 segment to via V22 to M2 segment 2902-A to via V21 to cell-2. A problem with these proposals is a “short” 2920 (as known in the field), an area of overlap where the proposed routes re-use the same portion of a route.

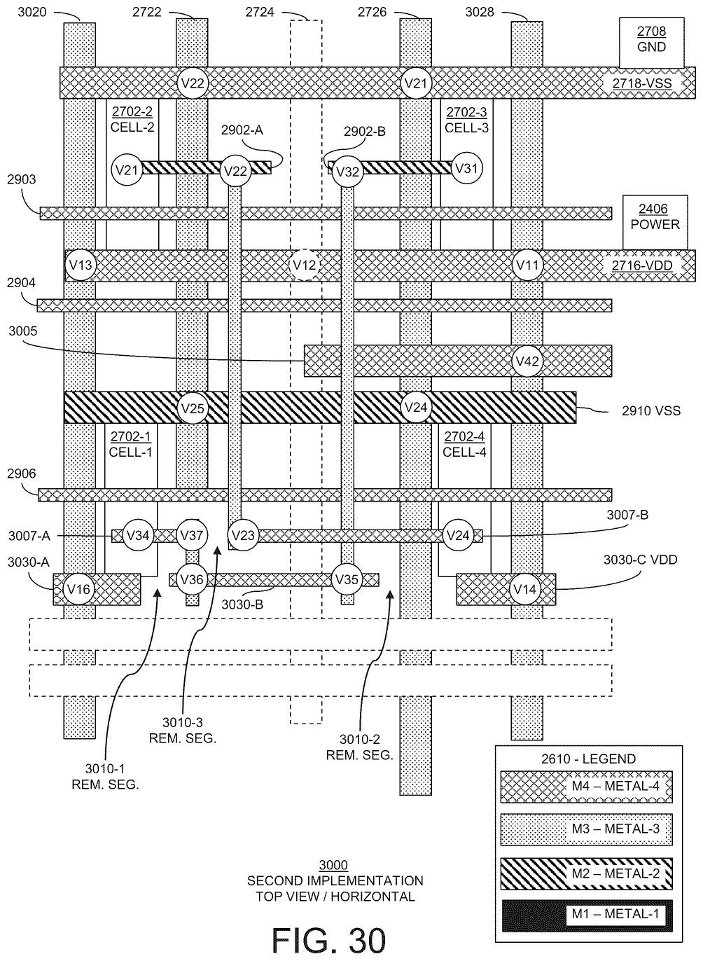

FIG. 30 is a diagram of a second implementation 3000, consistent with disclosed embodiments. The current figure builds on FIG. 29, continuing with a solution to the current exemplary problem. One or more portions of one or more routes (2907; 2930) is replaced with one or more associated segments (3007-A, 3007-B; 3030-B). Each of the segments is independent (isolated, non-communicative, disjoined) from adjacent portions of the routes (3007-B, 3007-A; 3030-A, 3030-C). Each of the segments is configured for communication of a signal other than a signal being communicated by each of the adjacent portions of the routes.

Refer again to FIG. 29 is an example of initial layout of cells and associated initial map of routes for the cells. FIG. 30 is an example of new layout of the cells with associated new map of routes for the cells. The FIG. 29 route 2907 has been replaced in the current figure with two routes, 3007-A and 3007-B. A gap 3010-3 separates routes, 3007-A and 3007-B. In addition, a portion of FIG. 29 route 2930 VDD has been replaced with route segment 3030-B. A gap 3010-1 separates route 3030-A from route 3030-B and a gap 3010-2 separates route 3030-B from route 3030-C. Other modifications have been made to the new layout and new map of routes, as will be discussed below. In the current figure, the desired implementation to connect between cell-1 and cell-3, and between cell-2 and cell-4 is now implemented using the new layout. A route for connection of cell-1 uses via V34 to M4 segment 3007-A, then via V37 to an M3 segment to via V36 to M4 segment 3030-B to via V35 to an M3 segment to via V32 to M2 segment 2902-B to via V31 to cell-3. A route for connection of cell-4 uses via V24 to M4 segment 3007-B, then via V23 to an M3 segment to via V22 to M2 segment 2902-A to via V21 to cell-2. The previous problem of short 2920 has been solved (eliminated).

The initial map can have at least one routing conflict. The routing conflict can be a routing short 2920 between cells 2702 of an IC.

The new routing map can include removing sections 3010 of the routes. Removing of sections 3010 of the routes can be of the adjacent portions of the routes. Removing of sections can be of power distribution routes unused by the new layout of the cells.

Power consumption of the new map of routes is preferably less than power consumption of the initial map of routes. Voltage drop to the cells of the new map of routes can be less than voltage drop to the cells of the initial map of routes. Voltage drop to a subset of the cells of the new map of routes is preferably less than a voltage drop to the subset cells of the initial map of routes.

The cells can be of an integrated circuit (IC) chip, and an average voltage drop to the cells of the new map of routes is preferably less than an average voltage drop to the cells of the initial map of routes. In the context of this document, the term “average voltage drop” generally refers to an average of differences between the voltage level at a voltage source 2406 and the voltage level at one or more cells.

In an optional implementation, a size of the segment (for example 3030-B) is different from a size of one or more of the adjacent portions (for example, 3030-A, 3030-C). The size of the segment can be smaller than the size of one or more of the adjacent portions. The size of a width of the segment can be smaller than the size of a width of one or more of the adjacent portions.

Features of the current implementation include spreading out cells to provide more options for routing, eliminating portions of existing routes (especially power stripes), adding additional routes (in particular to spread out power distribution), reallocating stripes for power/data usage, and reducing and spreading out power consumption of a set of cells. The generating of a new layout of cells with an associated new map of routes can be repeated or iterated. Each iteration can be evaluated (the new layout of cells and associated new map our routes for that iteration) based on a desired set of metrics to determine operational parameters for the iteration. A possible goal is to optimize (maximize and/or minimize metrics of a set of metrics) to decide on a preferred iteration with which to proceed.

Implementations facilitate re-distribution of power, at least in part to reduce voltage drop to cells. For example, the new segment 3030-B is designated to carry a data signal, so the size (width) of the route can be reduced in comparison to the original route 2930 that was designated for carrying power. The original power distribution route that used a single vertical M3 route 2724 is now implemented by removing (not building) M3 route 2724 and spreading (re-distributing) the power to new M3 vertical routes 3020 and 3028. Note, via V12 is shown in the current figure for reference, but as M3 route 2724 has been removed, via V12 is also removed (not built). The power source 2406 now can provide power (VDD) via M4 route 2716 to both M3 routes 3020 (using via V13) and 3028 (using via V11). M3 route 3020 can then provide power using via V16 to cell-1 and M3 route 3028 can provide power using via V14 to cell-4.

M4 route 3005 is an example of re-allocating a data signal FIG. 29 route 2905 to provide additional power distribution (from M4 route 3028 using via V42).

### Extra Power Via Standard DIMM Interface

Implementations of the innovative system described herein enables supplying of extra power via a standard interface, in particular via the standard DDR4 DIMM connector, while retaining operation with a standard DIMM (without interruption/breaking of the standard DIMM use). Implementations relate to computer DDR memory power supply ability. In general, a power supplying topology uses some pins from the standard DIMM connector to supply extra power to the DIMM via existing memory interfaces, while maintaining use of the standard DDR DIMM connector functionality.

DDR (double data rate) connector pinout is defined by JEDEC standard to let anyone who is developing DDR in a DIMM (dual in-line memory module) profile to work in any system. The Joint Electron Device Engineering Council (JEDEC) Standard No. 79-4C defines the DDR4 SDRAM (synchronous dynamic random-access memory) specification, including features, functionalities, AC (alternating current) and DC (direct current) characteristics, packages, and ball/signal assignments. The latest version, at the time of this application, is January 2020, available from JEDEC Solid State Technology Association, 3103 North 10th Street, Suite 240 South, Arlington, VA 22201-2107, www.jedec.org, and is incorporated by reference in its entirety herein.

XDIMMs™, XRAMs, and IMPUS™ are available from NeuroBlade Ltd., Tel Aviv, Israel.

Computational memories and components, including XRAMs and IMPUS™, are disclosed in the patent application PCT/US21/55472 for Memory Appliances for Memory Intensive Operations, incorporated herein in its entirety.

The disclosed system may be used as part of a data analytics acceleration architecture described in PCT/IB2018/000995 filed 30 Jul. 2018, PCT/IB2019/001005 filed 6 Sep. 2019, PCT/IB2020/000665 filed 13 Aug. 2020, PCT/US2021/055472 filed 18 Oct. 2021, and PCT/US2023/60142 filed 5 Jan. 2023.

A memory interface is limited by the established industry standard for how much power can be input, transferred, and output. For example, the standard DIMM interface defines 26 power pins, where each pin is limited to 0.75 A (amps) per pin and 1.2V per pin for a total current of 19.5 A and a total power of 23.4 W that can be supplied via the standard DIMM interface.

In contrast an innovative computational memory, for example the NeuroBlade XDIMM in a configuration including 16 XRAM computational memory chips per DIMM (XDIMM), requires more current than the standard DIMM interface is specified to supply. In one exemplary implementation, if each XRAM chip requires 2.8 W, and there are 16 XRAM chips on a DIMM, then the DIMM requires (2.8 W×16=˜) 45 W (and a corresponding current of (45 W/1.2V=˜) 37.5 A. This exemplary XRAM requirement of 37.5 A exceeds the 23.4 W available from a standard DIMM implementation. Unlike techniques from other fields such as overclocking, in the case of commercially available DIMM interfaces and DIMMs, the pins cannot be used to supply current or voltage beyond the tolerances of the specification, as this may result in destruction of the interface and/or various related hardware components.

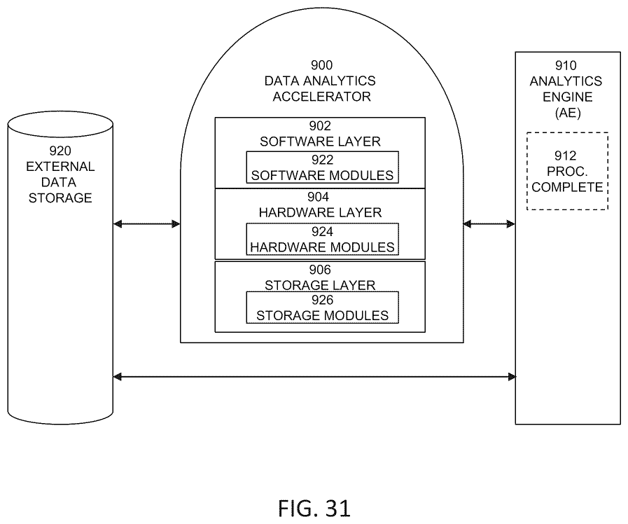

FIG. 31 is a diagrammatic representation of an architecture for a system and method for supplying extra power via a standard interface, consistent with disclosed embodiments. Implementations of the disclosed system and method can be used in various locations, such as in the hardware layer 904 and in the storage layer 906. The disclosed system is particularly useful for processing in memory, such as the IMPU 628 and DIMM (XDIMM) 626.

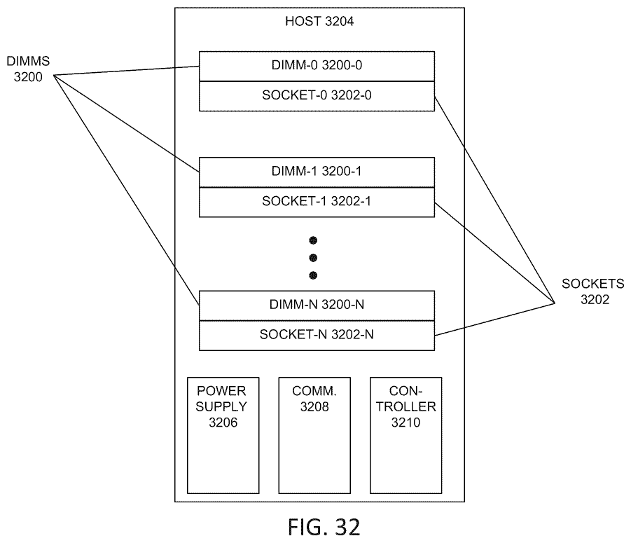

FIG. 32 is a diagrammatic representation of DIMM deployment, consistent with disclosed embodiments. One or more DIMMs 3200 (shown as exemplary DIMM-0, 3200-0 DIMM-1 3200-1, to DIMM-N 3200-N) are each mounted in a respective DIMM connector 3202 (shown as exemplary SOCKET-0, 3202-0 SOCKET-1 3202-1, to SOCKET-N 3202-N), also referred to in the field as a socket or interface. The DIMM connector 3202 implements an interface with the DIMM. For simplicity in the current description, the DIMM connectors 3202 are shown mounted in a host 3204. One skilled in the art will understand that the host 3204 can be a computer motherboard, expansion board, chassis, and the like. The host 3204 may include other modules, some examples of which are shown as a power supply 3206, communications 3208, and a controller 3210 (to include master controllers, CPUs, etc.).

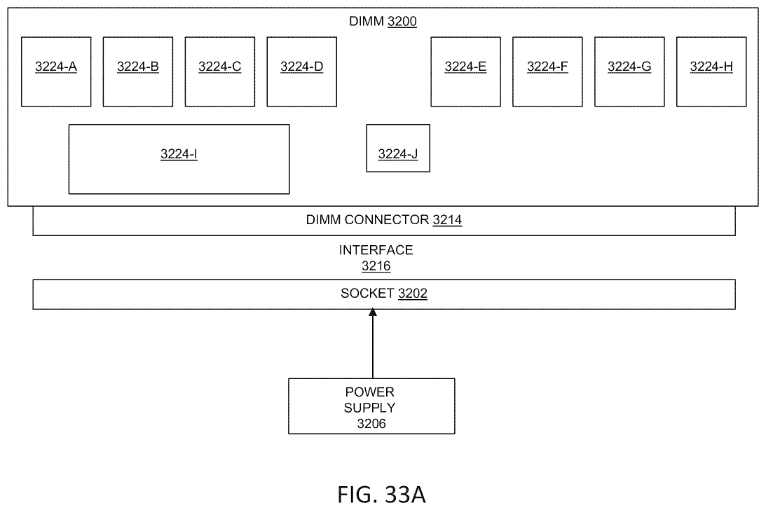

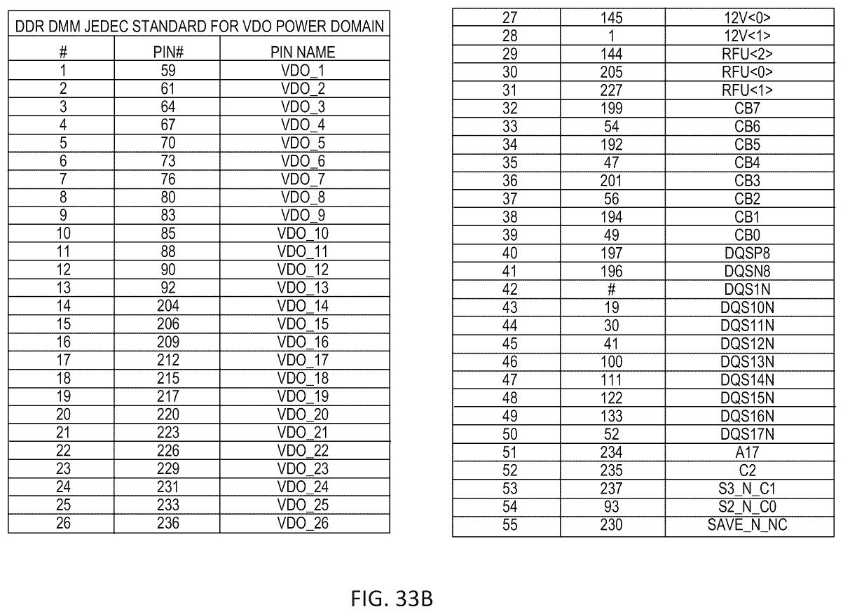

FIG. 33A is a diagrammatic representation of a DIMM pin connections, consistent with disclosed embodiments. FIG. 33B is a corresponding chart of pin connections, consistent with disclosed embodiments. The DIMM card 3200 may include an industry standard pin connector 3214, and one or more components 3624. The components 3224 shown as exemplary components 3224-A to 3224-J. Exemplary components 3224 may include one or more memory chips, control modules, power distribution, and similar. An interface 3216 operationally connects the DIMM 3200 via the DIMM connector 3214 to the associated socket 3202.

A solution would be to look for unused pins in the DIMM interface, and use these unused, extra pins, to transfer additional power to the DIMM. However, in the DIMM standard, there are only four declared unused pins (DDR4 RFU<0:3> and SAVE_N_NC). As there are not enough unused/extra/not connected pins in the standard interface to support the exemplary XRAM configuration, another solution is needed to provide extra power to the DIMM.

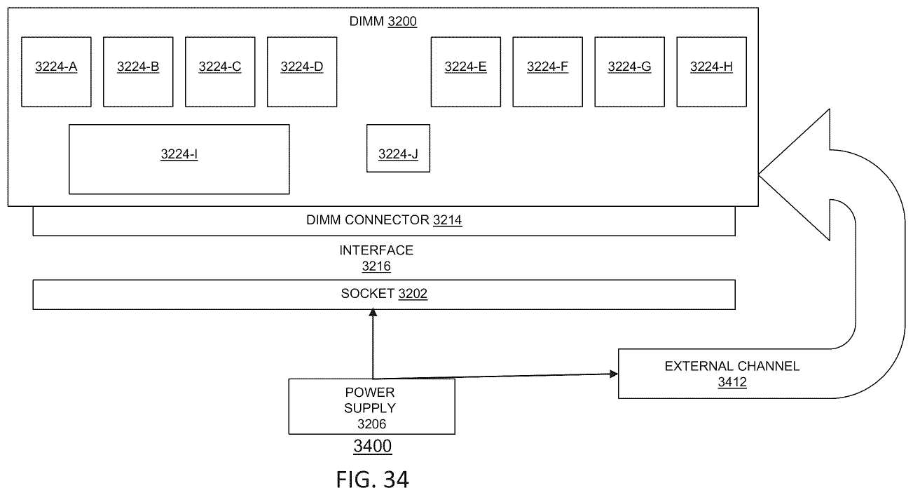

FIG. 34 is a diagrammatic representation of using an external cable to supply extra power, consistent with disclosed embodiments. An extra connector solution 3400 is to add an external channel 3412, for example, an external cable/power cord between the host and the DIMM, and supply the needed extra power via the external channel. Based on this description, one skilled in the art will be able to select connectors and cable(s) according to the required extra power. Power can be supplied from various points in the host, and/or other internal and external sources, for example from the host power supply 3206.

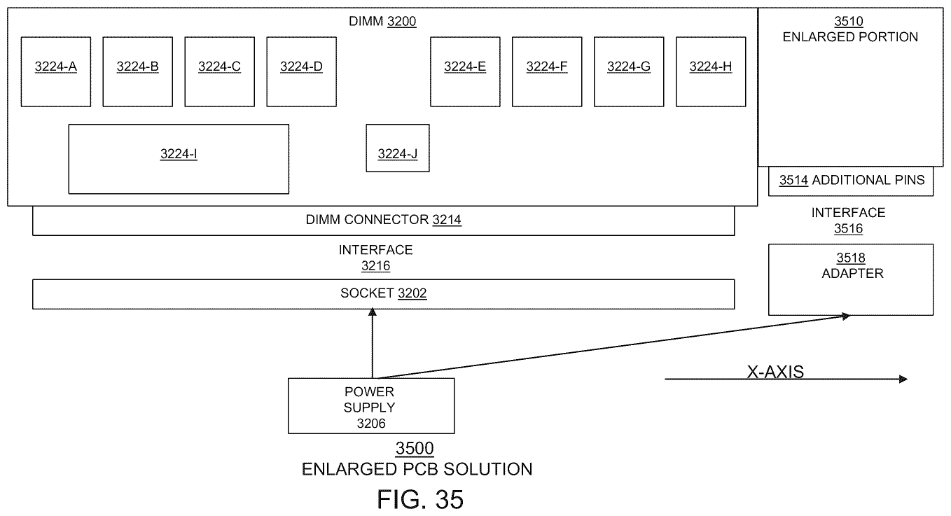

FIG. 35 is a diagrammatic representation of an enlarged printed circuit board (PCB) to supply extra power, consistent with disclosed embodiments. An enlarged board solution 3500 enlarges the standard DIMM PCB 3200 with an enlarged portion 3510 having additional connector pins 3514 (also known in the field as “golden fingers”). The enlarged portion 3510 can also be described as an elongated portion or additional portion and may be aligned with the x-axis of the standard DIMM connector. An adapter 3518 (board, cable, etc.) may be used to facilitate connections, for example, via an interface 3516, supplying signals, signal conversion, and/or supplying additional power from the host 3204 to the enlarged DIMM (3200 and 3510).

Based on this description, one skilled in the art will be able to design the enlarged portion 3510, design the adapter 3518, and select connectors, cable(s), etc. according to the required connections, such as extra power. Power can be supplied from various points in the host, and/or other internal and external sources, for example from the host power supply 3206.

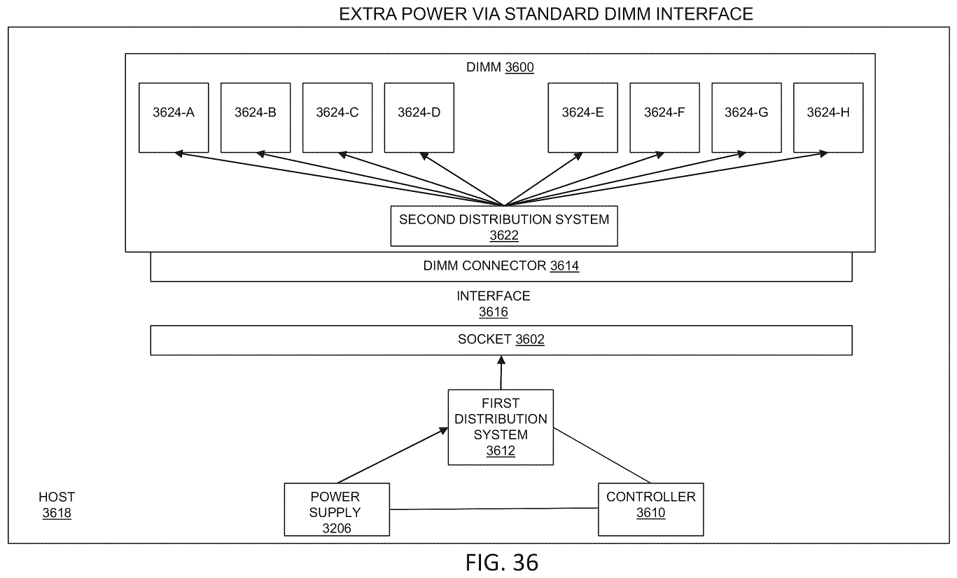

FIG. 36 is a diagrammatic representation of extra power via a standard DIMM interface, consistent with disclosed embodiments. A first module 3600, for example a DIMM card 3600 may include an industry standard pin connector 3614, a second distribution system 3622, and one or more components 3624. The components 3624 shown as exemplary components 3624-A to 3624-H. Exemplary components 3624 may include one or more memory chips, for example, the memory chips 624.

A socket 3602 may include an industry standard socket configuration. An interface 3616 provides communication between a host 3618 and the DIMM 3600. Reference to the interface 3616 includes a physical interface. References in this description to the interface 3616 may also refer to the logical, and/or protocol used by the interface 3616. A controller 3610 may be operationally connected to components of the host, for example to the power supply 3206, first distribution system 3612, the socket 3602 and other components such as FPGAs and other modules. Alternatively, FPGAs and other modules may communicate via the memory controller 3610 to the socket 3602 for communication such as reading and writing to/from the DIMM 3600. A power supply 3206 supplies power, for example via the first distribution system 3612 to the socket and/or indirectly via other modules. The supplying of power may be under control of the controller 3610. The first distribution system may include one or more conductors, active and passive components, directly or indirectly to components such as the interface 3616.

Using a standard DIMM interface is desirable, for example, to maintain compatibility with the existing infrastructure and commercially available DIMM hardware such as sockets, and to enable use of standard DIMMs (where the extra power capability is not required). A problem to be solved is how to use the standard DDR DIMM connector, while retaining operation (with a standard socket and DIMM), and also supplying additional power. The additional power required can be, for example, about 25 W and/or 20 A. An insight is that the current use of DDR4 DIMMs may be in the ×8 (“by eight”) configuration, which does not require the use of the ×4 (“by four”) DIMM interface.

1. There are 8 (eight) pins that are reserved in the DDR4 standard for use for ×4 implementation, but these 8 pins are not required for ×8 implementation (or higher implementations like ×16).

| PIN# | PIN_NAME |
|---|---|
| 19 | DQS10N |
| 30 | DQS11N |
| 41 | DQS12N |
| 100 | DQS13N |
| 111 | DQS14N |
| 122 | DQS15N |
| 133 | DQS16N |
| 52 | DQS17N |

2. There are 10 (ten) pins that are reserved for ECC, but a standard DIMM can function without using these ECC pins. In addition, in a XRAM configuration the ECC pins are not used.

| PIN# | PIN_NAME |
|---|---|
| 199 | CB7 |
| 54 | CB6 |
| 192 | CB5 |
| 47 | CB4 |
| 201 | CB3 |
| 56 | CB2 |
| 194 | CB1 |
| 49 | CB0 |
| 197 | DQSP8 |
| 196 | DQSN8 |

3. There are 11 (eleven) pins that are not connected and/or reserved for future use.

| PIN# | PIN_NAME |
|---|---|
| 145 | 12V <0> |
| 1 | 12V <1> |
| 144 | RFU <2> |
| 205 | RFU <0> |
| 227 | RFU <1> |
| 234 | A17 |
| 235 | C2 |
| 237 | S3_N_C1 |
| 93 | S2_N_C0 |
| 230 | SAVE_N_NC |
| 8 | DQS9N |

The above list gives a total of 29 pins that can be made available for transferring power to the DDR4 DIMM plus the original 26 pins described above, for a total of 55 pins, while maintaining the standard interface for ×8 DIMM functionality. A list of specific pins is in the figures. Doing some exemplary math, the additional 29 pins each limited to 0.75 A and 1.2V per pin for a total current of about 22 A and a total power of 26 W. The combined 55 pins, operating within the published standards, can provide up to about 41 A and 50 W.

The current example uses the DDR4 DIMM interface, however, this implementation is not limiting. In general, pins that are not being used for a particular implementation can be used for other functions, such as power transfer. This includes pins that are reserved for future use, not being used (for functions of operation, for example ECC pins are not required for use with XRAM chips), and not being used for communication (for example, ×4 pins are not used when operating in ×8 mode). Additionally, pins that have been deprecated can be used. When operating in a first mode (for example, ×8) pins reserved for a second mode (for example ×4) can be used for functions unrelated to (not required for implementation of) the first mode of operation.

It is foreseen that alternative and future interfaces will have different pinouts. A feature of implementations is the realization that previous technology pins, unused mode pins, and so forth, are available for use for alternate functions, such as power transfer. In the case of DDR4, the ×4 pins are available (in addition to unused and reserved pins). In DDR5, an option may be that the ×8 pins will be available as the ×16 or dual channel pins will be used. Alternatively, the ×16 pins may be available as they are not preferred over the ×8 interface for use in server class machines.

Note that the disclosed embodiments can be used in general to supply extra connections, for example, additional connections when in a particular mode of operation. The extra connections can be used for a variety of functions, including, but not limited to power, signaling, and data transfer. The connections can be via pins, or in general via signal connection areas.

The sections below provide further examples and detail regarding operation of the current embodiment. In general, a system includes an interface 3616 configured for communication between a first distribution system 3612 and a second distribution system 3622, the interface 3616 including a plurality of communication channels. A first subset of the communication channels, in a first mode of operation, is configured for use in the first mode of operation. A second subset of the communication channels, in a second mode of operation, is configured for use in the second mode of operation. The second subset of communication channels, in the first mode of operation being configured for use in the first mode of operation.

While the first mode of operation is active, the operation of the communication channels other than the second subset of communication channels may be maintained in accordance with operation when the second mode of operation is active.

The first mode of communication may include supplying power from the first distribution system 3612 via the first subset of communication channels to the second distribution system 3622. The second mode of communication may include supplying power from the first distribution system 3612 via the second subset of communication channels to the second distribution system 3622. The first mode of communication may include supplying power from the first distribution system 3612 via the first and second subsets of communication channels to the second distribution system 3622.

The first distribution system 3612 may be a power supply 3206 distribution on a host machine 3618 to the interface 3616. The second distribution system 3622 may be a power supply 3206 distribution on a memory card (such as the first module 3600) from the interface 3616.

The first subset of communication channels may be DIMM pins for ×8 mode of operation. The second subset of communication channels are DIMM pins selected from at least one of 19, 30, 41, 100, 111, 122, 133, and 52.

In an alternative embodiment, the system may include a plurality of communication channels. A first subset of the communication channels may be configured for use in a first mode of operation. A second subset of the communication channels may be configured for use in a second mode of operation. At least one portion of the second subset of communication channels may be configured for use in the first mode of operation.

The system may further include a controller 3610 operative to reconfigure at least one portion of the second subset of communication channels for use in the first mode of operation.

In an alternative embodiment, the system may include the interface 3616 configured for communication between the controller 3610 and the first module 3600. The interface 3616 includes a plurality of communication channels implementing a set of pre-defined signals. A first subset of the communication channels implements a first mode of operation and a second subset of the communication channels different from the first subset, in the first mode of operation implements other than the pre-defined signals.

The pre-defined signals for the second subset may be for a second mode of operation other than the first mode of operation. The operation of the second mode may be independent of operation of the first mode. The controller 3610 may be operable in the first mode of operation to reconfigure the second subset of communication channels for implementing other than the second mode of operation.

The communication channels may be configured to access computer memory. The communication channels may be deployed between a computer processor and computer memory.

The controller 3610 may be a memory controller. The controller 3610 may be a power supply controller.

The first module 3600 may be a computer memory module. The first module 3600 may be a memory. The first module 3600 may be a DIMM having an industry standard interface.

The interface 3616 may include two or more portions. At least one portion of the interface 3616 may include an industry standard DIMM card pin connector and at least a second portion of the interface 3616 may include an industry standard memory slot. The interface 3616 may include an industry standard DIMM card pin connector. The interface 3616 may be an industry standard DIMM card pin connector. The interface 3616 may include an industry standard memory slot. The interface 3616 may include a DIMM slot. The interface 3616 may be a DIMM slot.

The first module 3600 may be a DIMM. The interface 3616 may be a DIMM slot. The plurality of communication channels may be DIMM pins. The communication channels may be DDR4 DIMM interface.

The first mode of operation may be DDR4 ×8. The second mode of operation may be DDR4 ×4.

At least one portion of the second subset of communication channels may be configured or reconfigured for transfer of power. At least one portion of the second subset of communication channels may be configured or reconfigured for signaling. At least one portion of the second subset of communication channels may be configured or reconfigured for transfer of data. In the first mode of operation the second subset of communication channels may be deprecated. The second subset of communication channels may include ECC.

While the first mode of operation is active, the operation of the communication channels other than the second subset of communication channels may be maintained in accordance with operation when the second mode of operation is active.

Note that the above-described examples, numbers used, and exemplary calculations are to assist in the description of this embodiment. Inadvertent typographical errors, mathematical errors, and/or the use of simplified calculations do not detract from the utility and basic advantages of the disclosed embodiments.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

Note that the above-described examples, numbers used, and exemplary calculations are to assist in the description of this embodiment. Inadvertent typographical errors, mathematical errors, and/or the use of simplified calculations do not detract from the utility and basic advantages of the disclosed embodiments.

To the extent that the appended claims have been drafted without multiple dependencies, this has been done only to accommodate formal requirements in jurisdictions that do not allow such multiple dependencies. Note that all possible combinations of features that would be implied by rendering the claims multiply dependent are explicitly envisaged and should be considered part of the disclosed embodiments.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the disclosed embodiments, which are, for clarity, described in the context of separate embodiments, can also be provided in combination in a single embodiment. Conversely, various features of the disclosed embodiments, which are, for brevity, described in the context of a single embodiment, can also be provided separately or in any suitable sub-combination or as suitable in any other described embodiment of the disclosed embodiments. Certain features described in the context of various embodiments are not to be considered essential features of those embodiments, unless the embodiment is inoperative without those elements.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A microprocessor including a function-specific architecture, the microprocessor comprising:
an interface configured to communicate with an external memory via at least one memory channel;
a first architecture block configured to perform a first task associated with a thread;
a second architecture block configured to perform a second task associated with the thread, wherein the second task includes a memory access via the at least one memory channel; and
a third architecture block configured to perform a third task associated with the thread, wherein the first architecture block, the second architecture block, and the third architecture block are configured to operate in parallel such that the first task, the second task, and the third task are all completed during a single clock cycle associated with the microprocessor.

2. The microprocessor of claim 1, wherein the first task includes a thread context restore operation.

3. The microprocessor of claim 1, wherein the third task includes a thread context store operation.

4. The microprocessor of claim 1, wherein during a first clock cycle associated with the microprocessor and for a first retrieved thread: a thread context restore operation is performed by the first architecture block, a memory access operation is performed by the second architecture block, and a thread context store operation is performed by the third architecture block; during a second clock cycle associated with the microprocessor and for a second retrieved thread, wherein the second clock cycle immediately follows the first clock cycle, a thread context restore operation is performed by the first architecture block, a memory access operation is performed by the second architecture block, and a thread context store operation is performed by the third architecture bloc; and wherein the memory access operation performed by the second architecture block during the first or second clock cycle is either a READ or a WRITE operation.

5. The microprocessor of claim 4, wherein the second architecture block includes a first segment configured to perform a READ memory access and a second segment configured to perform a WRITE memory access.

6. The microprocessor of claim 1, wherein the second architecture block is configured to perform a READ memory access via the at least one memory channel, and wherein the microprocessor further comprises a fourth architecture block configured to perform a WRITE memory access via the at least one memory channel.

7. The microprocessor of claim 6, wherein during a first clock cycle associated with the microprocessor and for a first retrieved thread: a thread context restore operation is performed by the first architecture block, a READ memory access operation is performed by the second architecture block, and a thread context store operation is performed by the third architecture block; and during a second clock cycle associated with the microprocessor and for a second retrieved thread, wherein the second clock cycle immediately follows the first clock cycle, a WRITE memory access operation is performed by the fourth architecture block.

8. The microprocessor of claim 1, wherein the microprocessor further comprises a fourth architecture block configured to execute, during the single clock cycle, a data operation relative to data received as a result of an earlier completed READ request.

9. The microprocessor of claim 8, wherein the data operation includes generation of a read request specifying a second memory location different from a first memory location associated with the earlier completed READ request.

10. The microprocessor of claim 1, further comprising one or more controllers and associated multiplexers configured to select the thread from at least one thread stack including a plurality of pending threads.

11. (canceled)

12. (canceled)

13. The microprocessor of claim 10, wherein the at least one thread stack includes a first thread stack associated with thread read requests and a second thread stack associated with thread data returned from earlier thread read requests.

14. (canceled)

15. (canceled)

16. The microprocessor of claim 10, wherein the one or more controllers and associated multiplexers are configured to cause alignment of a first memory access operation, associated with a first thread and occurring during a first clock cycle, with a second memory access operation, associated with a second thread and occurring during a second clock cycle adjacent to the first clock cycle, wherein the first and second memory access operation is either a READ or a WRITE operation.

17. The microprocessor of claim 1, wherein at least one of the first task or the third task is associated with maintenance of a context associated with the thread.

18.-21. (canceled)

22. The microprocessor of claim 1, wherein the at least one memory channel includes two or more memory channels.

23.-26. (canceled)

27. The microprocessor of claim 1, wherein the microprocessor is a multi-threading microprocessor.

28. The microprocessor of claim 1, wherein at least one of the first architecture block, the second architecture block, or the third architecture block is implemented using a field programmable gate array.

29. The microprocessor of claim 1, wherein at least one of the first architecture block, the second architecture block, or the third architecture block is implemented using a programmable state machine, wherein the context of the state machine is stored.

30. The microprocessor of claim 1, wherein the first task, the second task, and the third task are associated with a key value operation.

31. The microprocessor of claim 1, wherein the microprocessor is included as part of a hardware layer of a data analytics accelerator.

32. The microprocessor of claim 1, wherein the microprocessor is a pipelined processor configured to coordinate pipelined operations on a plurality of threads by context switching among the plurality of threads.
